(19) United States
(12) Patent Application Publication
(10) Pub. No.: US 2025/0386092 A1
(43) Pub. Date: Dec. 18, 2025

(54) SYSTEMS AND METHODS FOR IMAGE CAPTURE

(71) Applicant: HOVER INC., San Francisco, CA (US)

(72) Inventors: Atulya Shree, Vancouver (CA); Giridhar MURALI, San Francisco, CA (US); Domenico CURRO, San Francisco, CA (US)

(21) Appl. No.: 18/274,717

(22) PCT Filed: Jan. 27, 2022
(86) PCT No.: PCT/US2022/014164

§ 371 Date: Jul. 28, 2023

Related U.S. Application Data
(63) Continuation of application No. 17/163,043, filed on Jan. 29, 2021, now Pat. No. 12,445,717.
(60) Provisional application No. 63/142,816, filed on Jan. 28, 2021.
(60) Provisional application No. 63/142,795, filed on Jan. 28, 2021.
(60) Provisional application No. 63/214,500, filed on Jun. 24, 2021.
(60) Provisional application No. 63/255,158, filed on Oct. 13, 2021.
(60) Provisional application No. 63/271,081, filed on Oct. 22, 2021.
(60) Provisional application No. 63/302,022, filed on Jan. 21, 2022.

(51) Int. Cl. H04N 23/60; G06F 3/16; G06T 7/11; G06T 7/12; G06T 7/174; G06T 7/277; G06T 7/73; G06T 15/00; G06T 17/00; G06V 10/26; G06V 10/44; G06V 30/19; G06V 30/414; H04N 23/63

(52) U.S. Cl. CPC H04N 23/64; G06T 7/11; G06T 7/12; G06T 7/174; G06T 7/277; G06T 7/74; G06T 17/00; G06V 10/26; G06V 10/44; H04N 23/635; G06F 3/167; G06T 15/00; G06T 2207/20072; G06T 2207/20084; G06T 2210/00; G06V 30/19013; G06V 30/19107; G06V 30/414

(57) ABSTRACT

An image set is refined by selection criteria among captured images, such that images within the set must satisfy criteria such as feature matching among a plurality of frames or positional changes between frame pairs or sufficient overlap of reprojected points of one image into another image such that the reprojected points or features are observed in the frustum or coordinate space of the another image.

### RELATION TO OTHER APPLICATIONS

This application is related to the following applications, each owned by applicant: U.S. Provisional Patent Application No. 63/142,816 titled, “SYSTEMS AND METHODS IN PROCESSING IMAGERY,” filed on Jan. 28, 2021; U.S. Provisional Patent Application No. 63/142,795 titled, “SYSTEMS AND METHODS IN PROCESSING IMAGERY,” filed on Jan. 28, 2021; U.S. patent application Ser. No. 17/163,043 titled “TECHNIQUES FOR ENHANCED IMAGE CAPTURE USING A COMPUTER-VISION NETWORK,” filed on Jan. 29, 2021; U.S. Provisional Patent Application No. 63/214,500 titled “SYSTEMS AND METHODS FOR IMAGE CAPTURE,” filed on Jun. 24, 2021; U.S. Provisional Patent Application No. 63/255,158 titled “SYSTEMS AND METHODS IN IMAGE CAPTURE,” filed on Oct. 13, 2021; U.S. Provisional Patent Application No. 63/271,081 titled “SYSTEMS AND METHODS IN IMAGE CAPTURE,” filed on Oct. 22, 2021; and U.S. Provisional Patent Application No. 63/302,022 titled “SYSTEMS AND METHODS FOR IMAGE CAPTURE,” filed on Jan. 21, 2022. The contents of each are hereby incorporated by reference in their entirety.

### FIELD OF THE INVENTION

This disclosure relates to image capture of an intended subject and subsequent processing or association with other images for specified purposes.

### BACKGROUND

Computer vision techniques and capabilities continue to improve. A limiting factor in any computer vision pipeline is the input image or images themselves. Low resolution photos, blur, occlusion and subjects or portions thereof out of frame all limit the full scope of analyses that computer vision techniques can provide. Providing real time feedback through an imaging system can direct improved capture of a given subject, thereby enabling enhanced use and output of a given captured image. Improving image quality or image quantity to overcome individual image shortcomings in a reconstruction pipeline may adversely increase data input volumes.

In image aggregation techniques wherein multiple images are used to perform a task, such as scene reconstruction, efficient selection of input images improves system resource management. Efficient selection may be qualitative (such as the aforementioned resolution, blur reduction, framing) or quantitative (for example, a minimum number of images to perform a given task).

### SUMMARY OF THE INVENTION

Described herein are various methods for analyzing viewfinder or display contents to direct adjustment of a camera parameter (such as translation or rotational pose), or preprocess display of subjects before computer vision techniques are applied, or selectively extract relevant images for a specified computer vision technique.

Prior reconstruction techniques may be characterized as passive reception. A reconstruction pipeline receives images and then performs operations upon them. Successfully completing a given task is at the mercy of the photos received; the pipeline's operations do not influence collection. Application of examples described herein couple pipeline requirements and capabilities with collection parameters and limitations. For example, the more an object to be reconstructed is out of any one frame, the less value that frame has in a reconstruction pipeline as fewer features and actionable data about the object is captured. Prompts to properly frame a given object improves the value of that image in a reconstruction pipeline. Similarly, insufficient coverage of an object (for example, not enough photos with distinct views of an object) may not give a reconstruction pipeline enough data to reconstruct an object in three dimensions (3D). At the same time, as the number of input images increase, the potential for redundant data decreases the value that any one image has (and a system has fewer computing resources to transmit and process the increased images). The examples discussed below for informed collection and reception improve the quality of image processes' output and operation.

Though the fields of photography, localization, or mapping may broadly utilize the techniques described herein, specific discussion will be made using residential homes as the exemplary subject of an image capture, and photogrammetry and digital reconstruction the illustrative use cases.

Image analysis techniques can produce a vast amount of information, for example classifying objects within a frame or extracting elements like lines within a structure, but they are nonetheless limited by the quality of the original image or images. Images in low light conditions or poorly framed subjects may omit valuable information and preclude full exploitation of data in the image. Simple techniques such as zooming or cropping may correct for some framing errors, but not all, and editing effects such as simulated exposure settings may adjust pixels value to enhance certain aspects of an image, but such enhancement does not replace pixels that were never captured (for example, glare or contrast differentials). Image sets that utilize a plurality of images of a subject can alleviate any shortcomings of the quality in any one image, and improved association of images ensures relevant information is shared across the image set and a reconstruction pipeline can benefit from the set. For example, ten images of a house's front façade may provide robust coverage of that façade and mutually support each other for any occlusions, blur or other artifacts any one image may have; however, fewer photos may provide the same desired coverage and provide linking associations with additional images of other façades that a reconstruction pipeline would rely on to build the entire house in 3D.

Specific image processing techniques may require specific image inputs, it is therefore desirable to prompt capture of a subject in a way that maximizes the potential to capture those inputs at the time of capture, rather than rely on editing techniques in pre- or post-processing steps.

In 3D modeling especially, two-dimensional (2D) images of a to-be-modeled subject can be of varying utility. For example, to construct a 3D representation of a residential building, a series of 2D images of the building can be taken from various angles circumventing the building, such as from a smartphone, to capture various geometries and features of the building. Identifying corresponding features between images is critical to understand how the images relate to one another and to reconstruct the subject in 3D space based on relationships among those corresponding features and attendant camera poses.

This problem is compounded for ground-level images, as opposed to aerial or oblique images taken from a position above a subject. Ground-level images, such as ones captured by a smartphone without ancillary equipment like ladders or booms, are those with an optical axis from the imager (also referred to as an imaging device or image capture device) to the subject that is substantially parallel to the ground surface (or orthogonal to gravity). With such imagery, successive photos of a subject are prone to wide baseline rotation changes, and feature correspondences between images are less frequent.

FIG. 1 illustrates this technical challenge for ground-based images in 3D reconstruction. Subject 100 has multiple geometric features such as post 112, door 114, post 104, rake 102, and post 122. Each of these geometric features as captured in images represent useful data to understand how the subject is to be reconstructed. Not all of the features, however, are viewable from all camera positions. Camera position 130 views subject 100 through a frustum with viewing pane 132, and camera position 140 views subject 100 through a frustum with viewing pane 142. The rotation 150 between positions 130 and 140 forfeits many of the features viewable from either position, shrinking the set of eligible correspondences to features 102 and 104 only.

This contrasts with aerial imagery that has an optical axis vector that will always have a common direction: towards the ground rather than parallel with. Because of this optical axis consistency in aerial imagery (or oblique imagery) whether from a satellite platform, high altitude aircraft, or low altitude drone, the wide baseline rotation problem of ground-level images is lessened if not outright obviated. Aerial and oblique images enjoy common correspondences across images as the subject consistently displays a common surface or feature to the camera, and a degree of freedom of the camera's optical axis is more constrained. In the case of building structures, the common surface(s) or features(s) in question is one or more roof facets. FIG. 2 illustrates this for subject roof 200 having features roofline 202 and ridgeline 204. FIG. 2 is a top plan view, meaning the imager is directly above the subject but one of skill in the art will appreciate that the principles illustrated by FIG. 2 apply to oblique images as well, wherein the imager is still above the subject but the optical axis is not directly down as in a top plan view. Because the view of aerial imagery is from above, the viewable portion of subject 302 appears only as an outline of the roof as opposed to the richer data of subject 100 for ground images. As the aerial camera position changes from position 222 to 232 by rotation 240, the view of subject roof 200 through either viewing pane 224 or 234 produces observation of the same features for correspondences.

In some embodiments, it is critical then for 2D image inputs from ground-level or smartphone images to maximize the amount of data related to a subject in each image frame, at least to facilitate correspondence generation for 3D reconstruction. In some examples, proper framing of the subject to capture as many features as possible per image frame will maximize the opportunity that at least one feature in an image will have a correspondence in another image and allow that feature to be used for reconstructing the subject in 3D space. In some examples, awareness of cumulative common features in any one frame informs the utility of such image frame for a given task such as camera pose derivation or reconstruction in 3D.

In some examples, increasing the number of captured images may also correct for the wide baseline problem described in FIG. 1. Instead of only two camera positions 130 and 140 that lend minimal correspondences between the images of those two positions, a plurality of additional camera positions between 130 and 140 could identify more corresponding features among the resultant pairs of camera positions, and for the aggregate images overall. Computing resources, especially for mobile platforms such as smartphones, and the limited memory become a competing interest in such a capture protocol or methodology. Additionally, the increased number of images require additional transmit time between devices and increased computation cycles to run reconstruction algorithms on the increased photo set. A device is forced to make a decision between using increased local resources to process the imagery or send larger data packets to remote servers with more computing resources. Techniques described herein address these shortcomings such as by identifying keyframes from among a plurality of image frames that each comprise information associated with features of other image frames or modifying transmission or uploading protocols.

In some embodiments, a target subject is identified within a camera's viewfinder or display (hereinafter either may be referred to simply as a “display”), and a bounding box is rendered around the subject. The bounding box may be a convex hull or quadrilateral otherwise that contains the subject, though other shapes are of course applicable. A pixel evaluator at the display's border may use a logic tool to determine whether pixels within the lines of pixels at the display's boundary comprises the bounding box or not. A pixel value at the display boundary held by the bounding box indicates the subject is not fully in the camera's field of view, i.e., the bounding box's attempt to envelop the subject reaches the display boundary before reaching the subject boundary. Corrective instructions can be displayed to the user, preferably concurrent with the camera's position but in some embodiments subsequent to a pixel evaluation at a given camera position, based on the pixel evaluation. For example, if the pixel evaluator detects bounding box values on the top border of the display, an instructive prompt to pan the camera upwards (either by translating or rotating or both) is displayed. If the pixel evaluator detects bounding box values at the upper and lower borders, then a prompt for the camera user to back up and increase distance between the subject and the camera is displayed.

In some embodiments, a segmentation mask is applied to the display image. The segmentation mask may be trained separately to detect certain objects in an image. The segmentation mask may be overlaid on the image, and a pixel evaluator determines whether a segmentation pixel is present at the border of the display. In some embodiments, the pixel evaluator displays corrective instructions based on a threshold number of pixels. In some embodiments, the threshold number is a percentage of boundary pixels with a segmentation mask pixel relative to all other pixels along the boundary. In some embodiments, the threshold number is a function of a related pixel dimension of the segmented subject and the number of segmented pixels present at the display border.

For 3D reconstruction from 2D images, additional image frames available as inputs can increase fidelity of the reconstruction by providing more views of a reconstructed object, thereby increasing the number of features and reconstruction attributes available for processing. Reconstruction is particularly enhanced with the improved localization and mapping techniques additional images enable. Additional feature matches between images constrains eligible camera positions (e.g., localization and pose), which in turn generates more accurate reconstructions based on the more reliable derived camera positions.

At the same time, each additional input image increases computing resources, requires more complex processing algorithms, and the larger resultant data package more difficult to transmit or store.

In some embodiments, at least one keyframe is identified from a plurality of image frames. Keyframes are selected based on progressive and cumulative attributes of other frames, such that each keyframe possesses an inter-image relationship to other image frames in the plurality of captured image frames. Keyframe selection is method of generating an end-use driven image set. For a reconstruction pipeline, the end-use driven purpose is derived camera pose solutions from the image set for which geometries within an image may be accurately reprojected relative to the data of derived camera poses. In some examples, each image frame within the selected set comprises a sufficient number of matched co-visible points or features with other image frames to derive the camera poses associated with each image frame in the cumulative set. Keyframe selection may also ensure features of the subject to be reconstructed are sufficiently captured, and coverage is complete. Not every image frame selected for the keyframe set must meet a common selection criteria; in some embodiments a single keyframe set may comprise image frames selected according to different algorithms. In other words, while keyframes will populate a keyframe set, not every frame in a keyframe set is a keyframe. While a keyframe set represents a minimization of image frames to localize the associated camera's poses and maintain feature coverage of the subject to be reconstructed, other images may populate the keyframe set to supplement or guide selection of keyframes also within the set.

In some embodiments, images sharing a qualified number of N-focal features with previous images, or are separated by a predetermined distance, are selected as a keyframe. In some embodiments, trifocal features are used to qualify keyframes (e.g., a feature is visible in a minimum of three images). Trifocal features, or otherwise N-focal features greater than 2, facilitate scaling consistency across a keyframe set as well. While image pairs may be able to triangulate common features in their respective images and a measured distance between the cameras of the image pairs can impart a scale for the collected image data, a separate pair of image frames using separate features may derive a different scale such that a reconstruction based on all of the images would have a variable scale based on the disparate image pairs. Trifocal features, or otherwise N-focal features greater than 2, increase the number of features viewable within greater number of image frame within a set, thereby reducing the likelihood of variable scaling or isolated clusters of image frames. In other words, scaling using triangulation of points across images has less deviation due to the increased commonality of triangulated points among more images.

In conjunction with an augmented reality camera output, 3D points identified in a keyframe may be reprojected across non-keyframe images to reduce jitter as to any one point. In other words, rather than project all points and features in every frame of an augmented reality framework, only those points and features qualified by a keyframe selection or satisfying an N-focal feature criteria are projected onto the scene.

In some examples, a series of candidate frames are identified, each candidate keyframe satisfying an N-focal requirement, and then further curation of candidate keyframes is performed according to secondary factors or processing such as image quality (e.g., how well the object is framed in an image, diversity of features captured, etc.).

In some examples, an image collection protocol periodically transmits at least one image to an intermediate processing resource. Periodic and progressive transmission to a remote server alleviate reconstruction resources on device and minimizes data packet transmission. Larger file sizes, dependent on transmission means, are prone to failure either by network bandwidth or system resources otherwise. Progressive transmission or upload also permits image processing techniques to occur in parallel to image collection, such that reconstruction of an object in 3D may begin while a device is capturing that object without computational cannibalism on device.

In some examples, camera angle scoring is conducted between an imager and subject being captured to determine an angular perspective between the two. Images wherein planar surfaces are angled relative to the imager are more valuable to reconstruction pipelines. For example, depth or vanishing points or camera intrinsics such as focal length are more easily derived or predicted for planar surfaces angled relative to an imager. Camera angle scores may indicate whether a particular image frame satisfies an intra-image parameter check such as in secondary processing for candidate frames.

In some examples, to account for feature matching algorithms that do not detect all features or lack robustness for confident matching of all detected features among image frames (for example for feature matching solutions on mobile networks that run lightweight machine learning models due to system resources), a quantitative overlap of reprojected of features from other image frames into an instant image frame with the features from the other image frame serves as a proxy for detected and matched features for identifying keyframes or candidate frames.

These and other embodiments, and the benefits they provide, are described more fully with reference to the figures and detailed description.

### BRIEF DESCRIPTION OF THE DRAWINGS

FIG. 1 illustrates changes in features across ground level camera views and 2D images of a subject from different positions, according to some examples.

FIG. 2 illustrates feature consistency across multiple aerial images.

FIG. 3 illustrates a framed subject in a camera display according to some examples.

FIG. 4 illustrates a bounding box around a subject in a display according to some examples.

FIGS. 5A-5D illustrate border or display boundary pixel relationships for instructive panning prompts on a display according to some examples.

FIGS. 6-7 illustrate instructive prompts for moving along an optical axis according to some examples.

FIG. 8 illustrates a boundary threshold relationship with a subject framing according to some examples.

FIG. 9 illustrates a segmentation mask overlaid on a subject according to some examples.

FIG. 10 illustrates a subject with a segmentation mask extending outside the boundary of a display according to some examples.

FIG. 11 illustrates instructive panning prompts on a display according to some examples.

FIGS. 12A-12C illustrate progress bar status indicators for subject positioning in a display according to some examples.

FIGS. 12D-12E illustrate a bounding box envelope over a segmentation mask according to some examples.

FIG. 13 illustrates a guided image capture system configuration according to some examples.

FIG. 14 illustrates a block diagram illustrating an inter-image parameter evaluation system, according to some examples.

FIG. 15 illustrates feature correspondences between images according to some examples.

FIGS. 16A-16C illustrate feature analysis or keyframe selection protocols based on selective feature matching according to some examples.

FIGS. 17A-17B illustrate feature detection or feature matching across image frames based on qualified matching with previous frames according to some examples.

FIG. 18 illustrates an example process for selecting keyframes according to some examples.

FIG. 19 illustrates camera poses for keyframe identification and selection according to some examples.

FIG. 20 illustrates frame reels or image tracks as a function of camera positions during image collection and keyframe analysis or selection according to some examples.

FIG. 21 illustrates camera poses for candidate frames in deferred keyframe selection according to some examples.

FIG. 22 illustrates frame reels or image tracks as a function of camera positions during image collection and candidate frame identification with deferred keyframe selection according to some examples.

FIG. 23 illustrates frame reels or image tracks as a function of camera position sequences during non-sequential keyframe selection according to some examples.

FIG. 24 illustrates image set data packaging according to some examples.

FIG. 25 illustrates high volume image collection from a plurality of camera poses according to some examples.

FIG. 26 illustrates increased image set data packaging according to some examples.

FIG. 27 illustrates increased image set data packaging according to some examples.

FIG. 28 illustrates intermediate transmission by progressive uploading via a capture session protocol according to some examples.

FIGS. 29A-29B illustrate feature matching output differences according to some examples.

FIGS. 30A-30B illustrate frustum analysis of reprojected features overlapping amongst images according to some examples.

FIG. 31 illustrates experimental evidence of reprojected features overlapping with previous images according to some examples.

FIG. 32 illustrates angular relationships from cameras to a subject, according to some examples.

FIG. 33 illustrates points on surfaces of a building scored by angular perspective, according to some examples.

FIG. 34 illustrates recommended camera pose for angular perspective scoring, according to some examples.

FIG. 35 illustrates aggregate angular perspective scoring for analyses, according to according to some examples.

### DETAILED DESCRIPTION

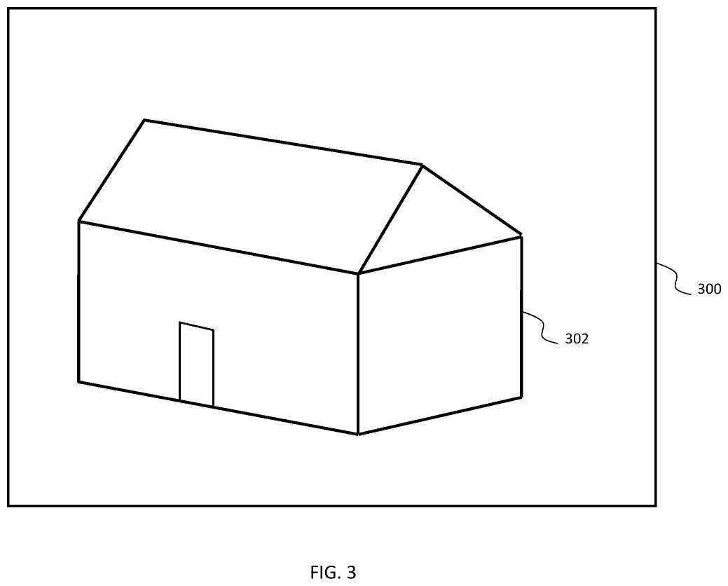

FIG. 3 depicts display 300 with an image of subject 302 within. Display 300, in some embodiments, is digital display having a resolution of a number of pixels in a first dimension and a number of pixels in a second dimension (i.e., the width and length of the display). Display 300 may be a smartphone display, a desktop computer display or other display apparatuses. Digital imaging systems themselves typically use CMOS sensors, and a display coupled to the CMOS sensor visually represents the data collected by the sensor. When a capture event is triggered (such as a user interaction, or automatic capture at certain timestamps or events) the data displayed at the time of the trigger is stored as the captured image.

As discussed above, captured images vary in degree of utility for certain use cases. Techniques described herein provide image processing and feedback to facilitate capturing, displaying, or storing captured images with rich data sets.

In some embodiments, an image based condition analysis is conducted. Preferably this analysis is conducted concurrent with rendering the subject on the display of the image capture device, but in some embodiments may be conducted subsequent to image capture. Image based conditions be intra-image or inter-image conditions. Intra-image conditions may evaluate a single image frame, exclusive to other image frames, whereas inter-image conditions may evaluate a single image frame in light of or in relation to other image frames.

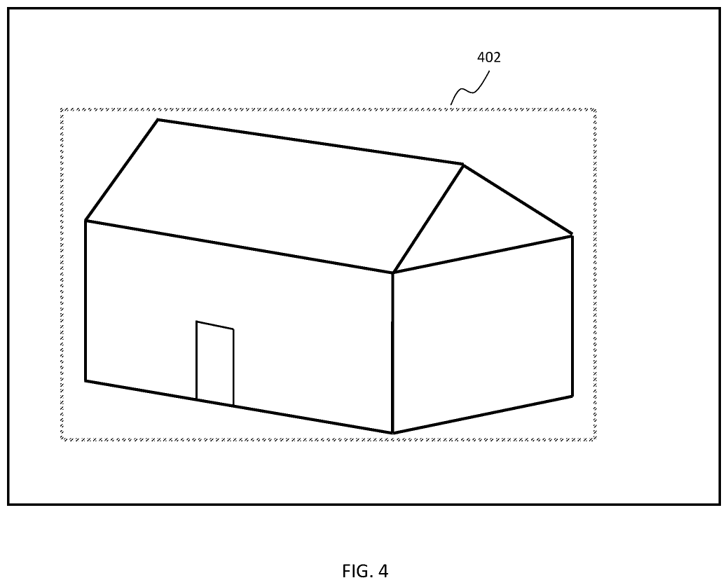

FIG. 4 illustrates the same display 300 and subject 302, but with a bounding box 402 overlaid on subject 302. In some embodiments, bounding box 402 is generated about the pixels of subject 302 using tensor product transformations, such as a finite element convex function or Delauney triangulation.

A bounding box is a polygon outline intended to contain at least all pixels of a subject as displayed within an image frame. A bounding box for a well framed image is more likely to comprise all pixels for a subject target of interest, while a bounding box for a poorly framed image will at least comprise the pixels of the subject of target of interest for those pixels within the display. In some embodiments, a closed bounding box at a display boundary implies additional pixels of a subject target of interest could be within the bounding box if instructive prompts for changes in framing are followed. In some embodiments, the bounding box is a convex hull. In some embodiments, and as illustrated in the figures, the bounding box is a simplified quadrilateral. In some embodiments, the bounding box is shown on display 300 as a pixel line (bounding box 402 is a dashed representation to ease of distinction with other aspects in the figures, other visual cues of representations are within the scope of the invention). In some embodiments, the bounding box is rendered by the display but not shown, in other words the bounding box has a pixel value along its lines, but display 300 does not project these values.

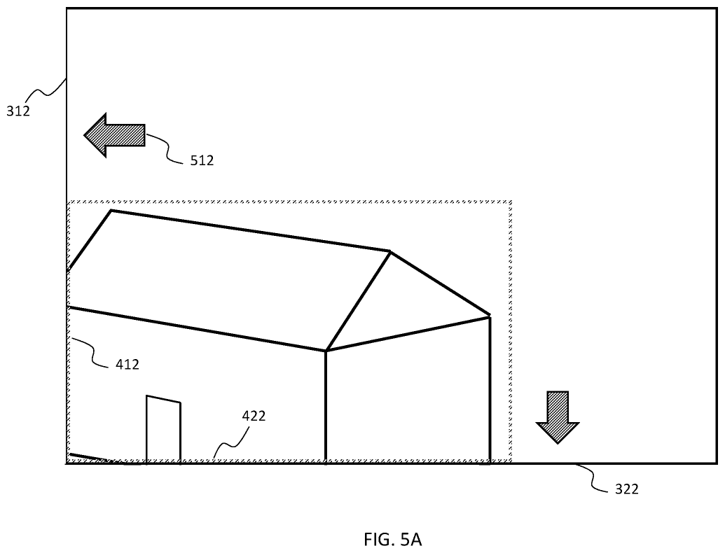

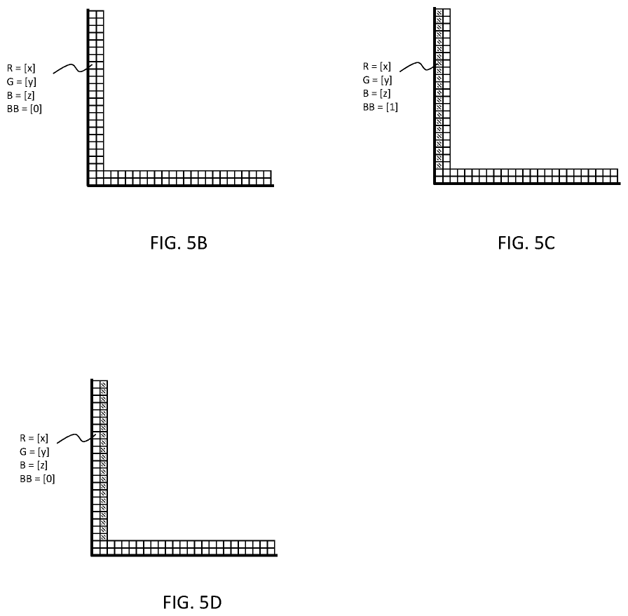

In FIG. 5A, subject 302 is not centered in display 300. As such, certain features would not be captured in the image if the trigger event were to occur, and less than the full data potential would be stored. Bounding box 402 is still overlaid, but because the subject extends out of the display's boundaries, bounding box sides 412 and 422 coincide with display boundaries 312 and 322 respectively.

In some embodiments, a border pixel evaluator runs a discretized analysis of a pixel value at the display 300 boundary. In the discretized analysis, the border pixel evaluator determines if a border pixel has a value characterized by the presence of a bounding box. In some embodiments, the display 300 rendering engine stores color values for a pixel (e.g., RGB) and other representation data such as bounding box values. If the border pixel evaluator determines there is a bounding box value at a border pixel, a framing condition is flagged and an instructive prompt is displayed in response to the location of the boundary pixel with the bounding box value.

For example, if the framing condition is flagged in response to a left border pixel containing a bounding box value, an instructive prompt to pan the camera to the left is displayed. Such instructive prompt may take the form of an arrow, such as arrow 512 in FIG. 5A, or other visual cues that indicate attention to the particular direction for the camera to move. Panning in this sense could mean a rotation of the camera about an axis, a translation of the camera position in a plane, or both. In some embodiments, the instructive prompt is displayed concurrent with a border pixel value containing a bounding box value. In some embodiments, multiple instructive prompts are displayed. FIG. 5A illustrates a situation where the left display border 312 and bottom display border 322 have pixels that contain a bounding box value and have instructive prompts responsively displayed to position the camera such that the subject within the bounding box is repositioned and no bounding box pixels are present at a display border.

In some embodiments, a single bounding box pixel (or segmentation mask pixel as described below) at a boundary pixel location will not flag for instructive prompt. A string of adjacent bounding box or segmentation pixels is required to initiate a condition flag. In some embodiments, a string of eight consecutive boundary pixels with a bounding box or segmentation mask value will initiate a flag for an instructive prompt.

FIG. 5B illustrates select display pixels rows and columns adjacent a display border. A pixel value is depicted conveying the image information (as shown RGB values), as well as a field for a bounding box value. For exemplary purposes only, a “zero” value indicates the bounding box does not occupy the pixel. FIG. 5B shows only the first two lines of pixels adjacent the display border for ease of description. FIG. 5C illustrates a situation where a bounding box occupies pixels at the boundary of a display (as illustrated by the grayscale fill of the pixels, one of skill in the art will appreciate that image data such as RGB values may also populate the pixel). As shown, the bounding box value for the border pixel evaluator is “one.” In some embodiments, the presence of a bounding box value of one at a display border pixel causes the corresponding instructive prompt, and the prompt persists in the display as long as a border pixel or string of border pixels has a “one” value for the bounding box.

In some embodiments, even when the border pixel value is “zero” the instructive prompt may display if there is a bounding box value in a pixel adjacent the border pixels. In some embodiments, noisy input for the bounding box may preclude precise pixel placement for the bounding box, or camera resolution may be so fine that slight camera motions could flag a pixel boundary value unnecessarily. To alleviate this sensitivity, in some embodiments the instructive prompt will display if there is a bounding box value of “one” within a threshold number of pixels from a display boundary. In some embodiments, such as depicted in FIG. 5D, the threshold pixel separation is less than two pixels, in some embodiments it is less than five pixels, in some embodiments it is less than ten pixels; in some embodiments, the threshold value is a percentage of the total display size. For example, if the display is x pixels wide, then the border pixels for evaluation is x/100 pixels and any bounding box value of “one” within that x/100 pixel area will trigger display of the instructive prompt.

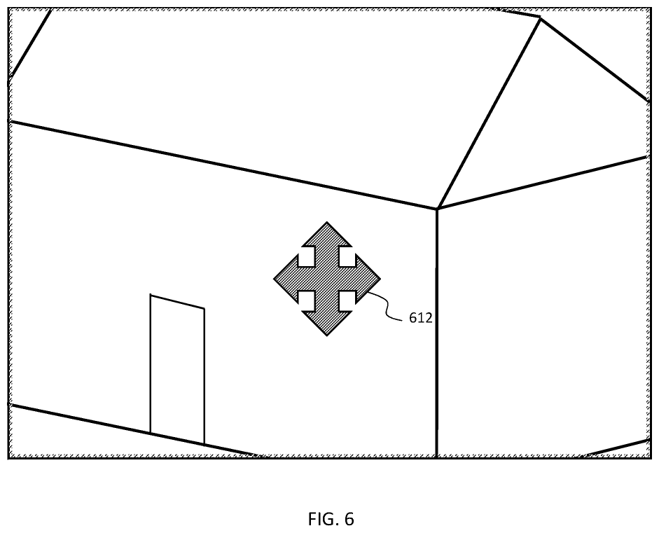

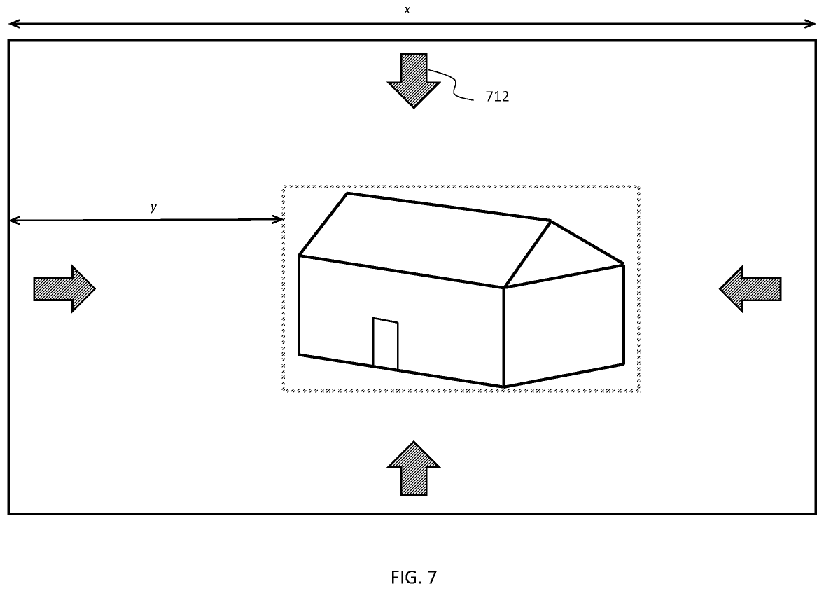

FIG. 6 illustrates a situation when the bounding box occupies all boundary pixel values, suggesting the camera is too close to the subject. Instructive prompt 612 indicates the user should back up, though text commands or verbal commands are enabled as well. Conversely, FIG. 7 depicts a scenario where the bounding box occupies pixels far from the boundary and instructive prompts 712 are directed to bringing the camera closer to the subject or to zoom the image closer. In determining whether a subject is too far from the camera, a relative distance of a bounding box value and a border pixel is calculated. For example, for a display x pixels wide, and a bounding box value around a subject occurs y pixels from a display boundary, a ratio of xy is calculated. Smaller ratios, such as less than 5:1 (i.e., for a 1064 pixel wide display, the bounding box occurs less than 213 pixels from a display border) would not trigger instructive prompt 712 for a closer subject capture. Various other sensitivities could apply, such that larger or smaller ratios to achieve the intended purpose for the particular use or camera are enabled.

The interaction between a closer subject capture as described in relation to FIG. 7 and a border threshold as described in FIG. 5D should also be considered. An overly large border threshold would prompt the user to back up, perhaps so far that it triggers the closer subject prompts to simultaneously instruct the use to get closer. In some embodiments, a mutual threshold value for the display is calculated. In some embodiments, the mutual threshold value is a qualitative score of how close a bounding box is to boundary separation value. A boundary separation value is determined, as described in relation to FIG. 5D above. The closer subject prompt then projects a feedback for how close a bounding box edge is to the separation threshold; the separation threshold value, then, uses an objective metric (e.g., the boundary separation value) for the closer subject prompt to measure against.

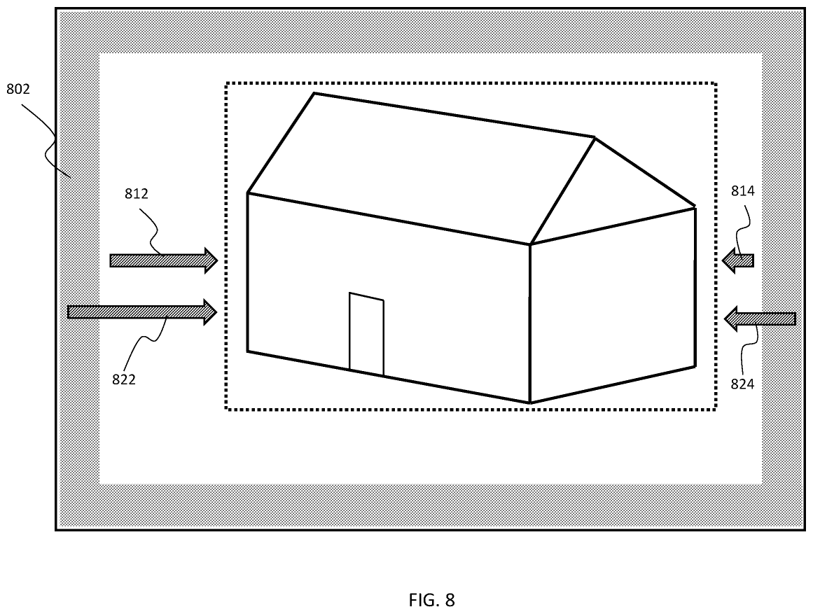

FIG. 8 illustrates a sample display with boundary threshold region 802 (e.g., the display boundary separation value as in FIG. 5D), indicating that any bounding box values at pixels within the region 802 implies the camera is too close to the subject and needs to be distanced further to bring the subject more within the display. In some embodiments, an instructive prompt 812 or 814 indicates the distance of a bounding box value to the threshold region 802. Similarly, in some embodiments there is no threshold region and the prompts 822 and 824 indicate the degree the camera should be adjusted to bring the subject more within the display boundaries directly. It will be appreciated that prompts 812, 814, 822 and 824 are dynamic in some embodiments, and may adjust in size or color to indicate suitability for the subject within the display. Though not pictured, status bars ranging from red (the bounding box is far from a boundary or threshold region) or green (the bounding box is near or at the display boundary or threshold region) are within the scope of invention, and not just the arrows as illustrated in FIG. 8. In some embodiments, a first prompt indicates a first type of instruction (e.g., bounding box occupies a display boundary) while a second prompt indicates a second type of instruction (e.g., bounding box is within a display boundary but outside a boundary separation value); disparate prompts may influence coarse or fine adjustments of a camera parameter. While discussed as positional changes, proper framing need not be through physical changes to the camera such as rotation or translation. Focal length changes, zooming otherwise, and other camera parameters may be adjusted to accommodate or satisfy a prompt for intra or inter image condition as discussed throughout.

In the context of “close” and “far,” in some embodiments, a bounding box within five percent of the pixel distance from the boundary or threshold region may be “close” while distances over twenty percent may be “far,” with intermediate indicators for ranges in between. In some embodiments, a bounding box smaller than ninety-nine percent of the display's total size is considered properly framed.

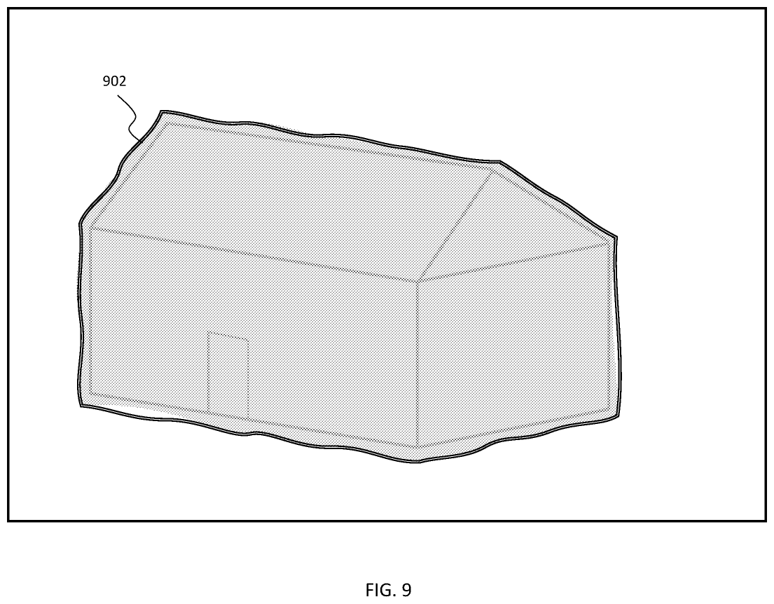

While bounding boxes are a simple and straightforward tool for analyzing an image position within a display, segmentation masks may provide more direct actionable feedback. FIG. 9 illustrates a segmentation mask 902 overlaid on subject 302. Segmentation mask 902 may be generated by a classifier or object identification module of an image capture device; MobileNet is an example of a classifier that runs on small devices. The classifier may be trained separately to identify specific objects within an image and provide a mask to that object. The contours of a segmentation mask are typically irregular at the pixel determination for where an object begins and the rest of the scene ends, due to bulk sensor use, variable illumination, weather effects and the like across images during training and application to an instant image frame and its own subjective parameters. The output can therefore appear noisy.

Despite this noise, the direct segmentation overlay still provides an accurate approximation of the subject's true presence in the display. While a bounding box usage increases the likelihood all pixels of a subject are within, there are still many pixels within a bounding box geometry that do not depict the subject.

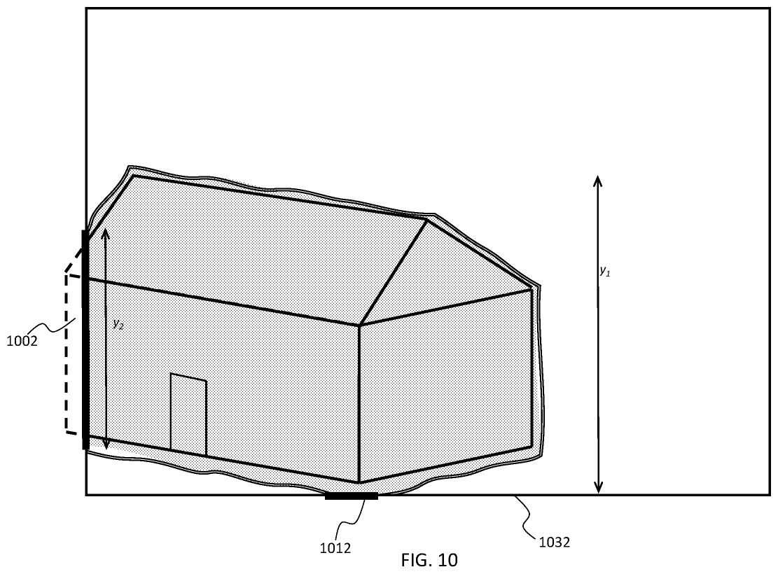

For example, in FIG. 10, only a small mask portion 1002 of subject 302 is outside the left boundary, and only mask portion 1012 touches the lower boundary (the subject's actual geometry is within that region of the display). In some embodiments, a pixel evaluator may use segmentation values at border pixels or elsewhere in the image to determine whether to generate instructive prompts.

For example, as in FIG. 10, if the mask portion 1012 that is along display border 1032 is only twenty pixels long and the entire display width is 1064 pixels, then no instructive prompts may be displayed as the minimal information in the portion outside of the display is unlikely to generate additional robust data. In some embodiments, this percentage tolerance is less than 1% of display pixel dimensions, in some embodiments it is less than 5%, in some embodiments it is less than 10%.

Looking to the left boundary, where portion 1002 is outside the display boundary and generates a border pixel line similar as in 1012, additional image analysis determinations can indicate whether instructive prompts are appropriate. A pixel evaluator can determine a height of the segmentation mask, such as in pixel height and depicted as y₁ in FIG. 10. The pixel evaluator can similarly calculate the dimension of portion 1002 that is along a border, depicted in FIG. 10 as y₂. A relationship between y₁ and y₂ indicates whether camera adjustments are appropriate to capture more of subject 302. While percentage of pixels relative to the entire display, such as described in relation to mask portion 1012 above are helpful, percentage of pixels relative to the total pixel size of the subject's segmentation mask, such as described in relation to region 1002 can be useful information as well for instructive prompt generation.

In some embodiments, a ratio of subject dimension y₁ and boundary portion y₂ are compared. In some embodiments, for a ratio of less than 5:1 (meaning subject height is more than five times the height of the portion at the display boundary) no instructive prompts are displayed. Use cases and camera resolutions may dictate alternative ratios.

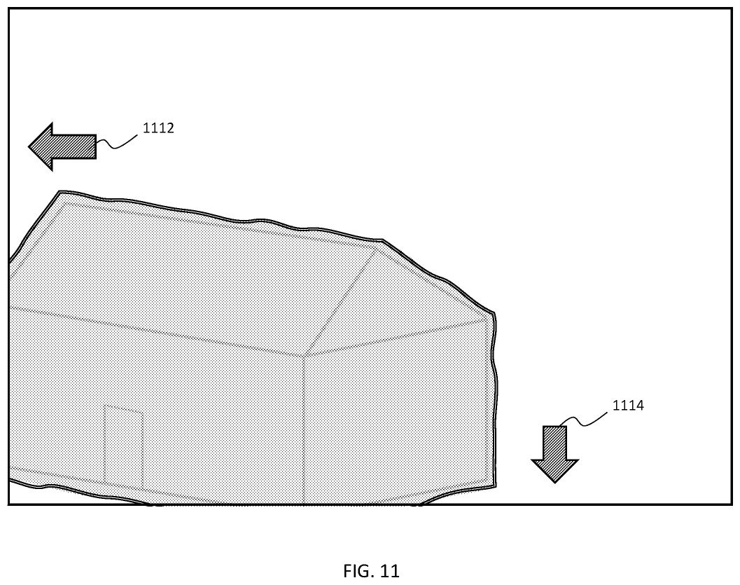

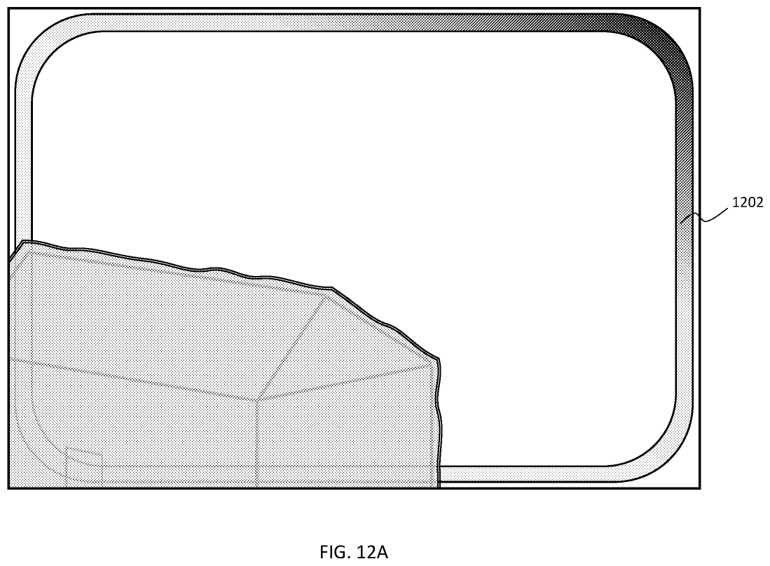

FIG. 11 illustrates similar instructive prompts for directing camera positions as described for bounding box calculations in FIG. 5A. Segmentation mask pixels along a left display boundary generate instructive prompt 1112 to pan the camera to the left, and segmentation mask pixels along the lower display boundary generate instructive prompt 1114 to pan the camera down. Though arrows are shown, other instructive prompts such as status bars, circular graphs, text instructions are also possible.

In some embodiments, whether instructive prompts for bounding boxes or segmentation masks, they are presented on the display as long as a boundary pixel value or boundary separation value contains a segmentation or bounding box value. In some embodiments, the prompt is transient, only displaying for a time interval so as not to clutter the display with information other than the subject and its framing. In some embodiments, the prompt is displayed after image capture, and instead of the pixel evaluator working upon the display pixels it performs similar functions as described herein for captured image pixels. In such embodiments, prompts are then presented on the display to direct a subsequent image capture. This way, the system captures at least some data from the first image, even if less than ideal. Not all camera positions are possible, for example if backing up to place a subject in frame requires the user to enter areas that are not accessible (e.g., private property, busy streets) then it is better to have a stored image with at least some data rather than continually prompt camera positions that cannot be achieved and generate no data as a result.

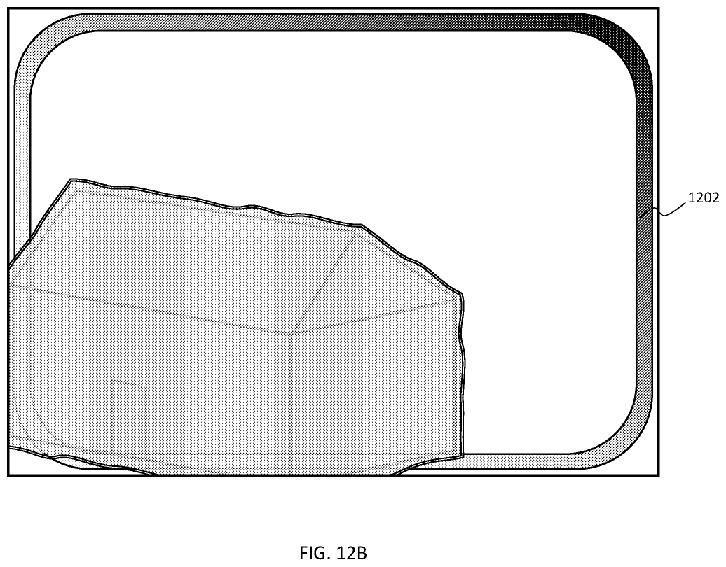

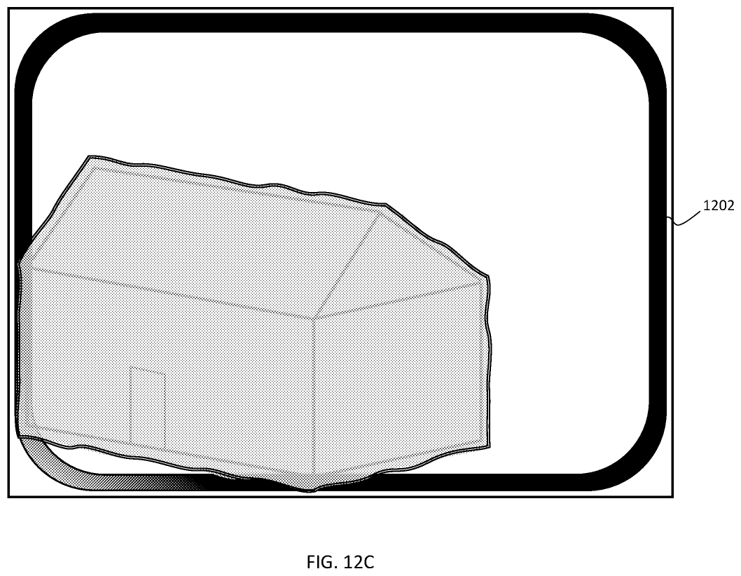

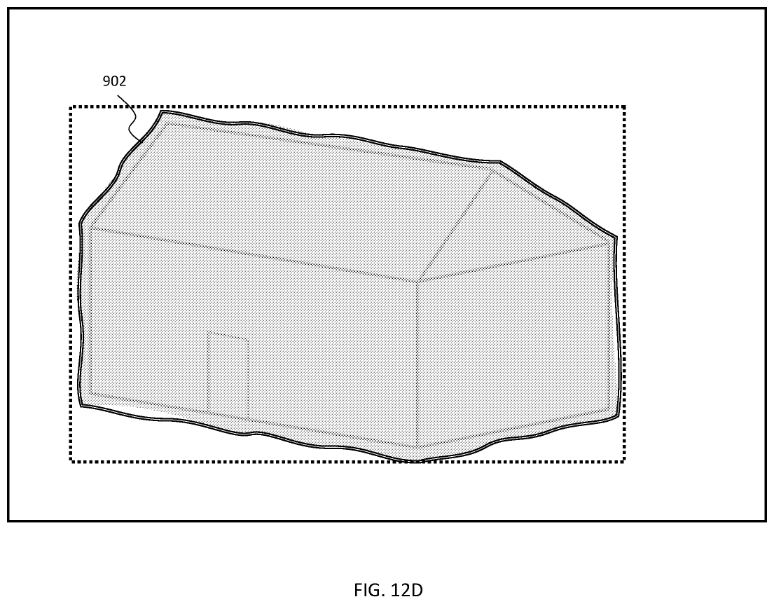

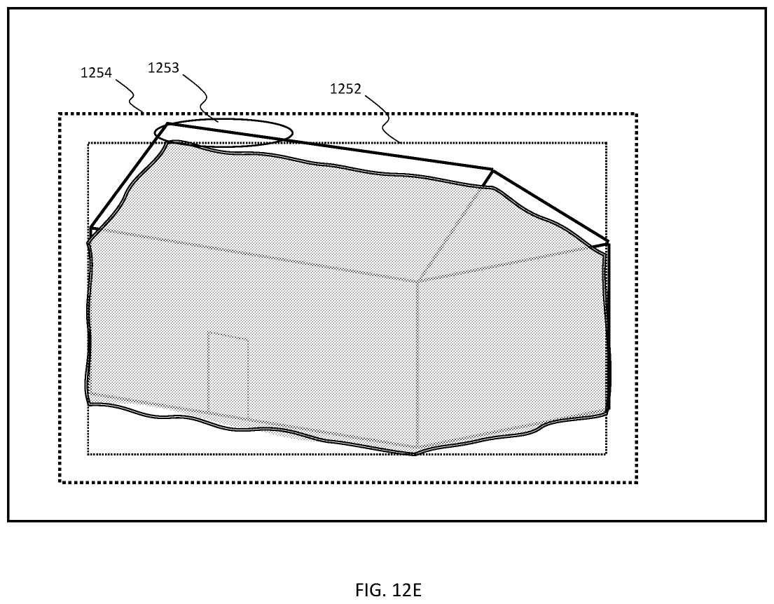

FIGS. 12A-C illustrate an alternative instructive prompt, though this and the arrows depicted in previous figures are no way limiting on the scope of feedback prompts. FIGS. 12A-C show progressive changes in a feedback status bar 1202. In FIG. 12A, subject 302 is in the lower left corner. Status bar 1202 is a gradient bar, with the lower and left portions not filled as the camera position needs to pan down and to the left. As the camera position changes, in FIG. 12B the status bar fills in to indicate the positional changes are increasing the status bar metrics until the well positioned camera display in 12C has all pixels of subject 302 and the status bar is filled. Note that while FIGS. 12A-C depict instructive prompt relative to a segmentation mask for a subject, this prompt is equally applicable to bounding box techniques as well.

In some embodiments, the segmentation mask is used to determine a bounding box size, but only the bounding box is displayed. An uppermost, lowermost, leftmost, and rightmost pixel, relative to the display pixel arrangement is identified and a bounding box drawn such that the lines tangentially intersect the respective pixels. FIG. 12D illustrates such an envelope bounding box, depicted as a quadrilateral, though other shapes and sizes are possible. In some embodiments, therefore, envelope bounding boxes are dynamically sized in response to the segmentation mask for the object in the display. This contrasts with fixed envelope bounding boxes for a predetermined objects with known sizes and proportions. FIG. 12D depicts both a segmentation mask and bounding box for illustrative purposes; in some embodiments only one or the other of the segmentation mask or bounding box are displayed. In some embodiments, both the segmentation mask and bounding box are displayed.

In some embodiments, a bounding box envelope fit to a segmentation mask includes a buffer portion, such that the bounding box does not tangentially touch a segmentation mask pixel. This reduces the impact that a noisy mask may have on accurately fitting a bounding box to the intended structure. FIG. 12E illustrates such a principle. Bounding box envelope 1252 is fit to the segmentation mask pixel contours to minimize the amount of area within that is not a segmented pixel. In doing so, region 1253 of the house is outside the bounding box. Framing optimizations for the entire home may fail in such a scenario: it is possible for region 1253 to be outside of the display, but the bounding box indicates that the subject is properly positioned. To prevent this, an overfit envelope 1254 is fit to the segmentation mask, such that the height and width of the bounding box envelope is larger than the height and width of the segmentation mask to minimize the impact of noise in the mask. In some embodiments, the overfit envelope is ten percent larger than the segmentation mask. In some embodiments the overfit envelope is twenty percent larger than the segmentation mask.

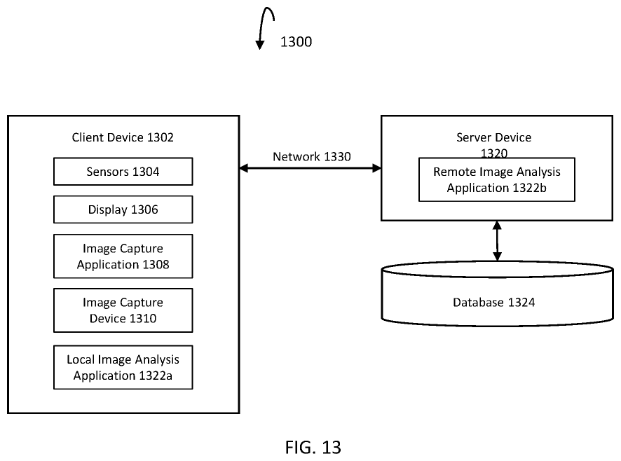

FIG. 13 illustrates an example system 1300 for capturing images for use in creating 3D models. System 1300 comprises a client device 1302 and a server device 1320 communicatively coupled via a network 1330. Server device 1320 is also communicatively coupled to a database 1324. Example system 1300 may include other devices, including client devices, server devices, and display devices, according to embodiments. For example, a plurality of client devices may be communicatively coupled to server device 1320. As another example, one or more of the services attributed to server device 1320 herein may run on other server devices that are communicatively coupled to network 1330.

Client device 1302 may be implemented by any type of computing device that is communicatively connected to network 1330. Example implementations of client device 1302 include, but is not limited to, workstations, personal computers, laptops, hand-held computer, wearable computers, cellular or mobile phones, portable digital assistants (PDA), tablet computers, digital cameras, and any other type of computing device. Although a single client device is depicted in FIG. 13, any number of client devices may be present.

In FIG. 13, client device 1302 comprises sensors 1304, display 1306, image capture application 1308, image capture device 1310, and local image analysis application 1322a. Client device 1302 is communicatively coupled to display 1306 for displaying data captured through a lens of image capture device 1310. Display 1306 may be configured to render and display data to be captured by image capture device 1310. Example implementations of a display device include a monitor, a screen, a touch screen, a projector, a light display, a display of a smartphone, tablet computer or mobile device, a television, etc.

Image capture device 1310 may be any device that can capture or record images and videos. For example, image capture device 1310 may be a built-in camera of client device 1302 or a digital camera communicatively coupled to client device 1302.

According to some embodiments, client device 1302 monitors and receives output generated by sensors 1304. Sensors 1304 may comprise one or more sensors communicatively coupled to client device 1302. Example sensors include, but are not limited to CMOS imaging sensors, accelerometers, altimeters, gyroscopes, magnetometers, temperature sensors, light sensors, and proximity sensors. In an embodiment, one or more sensors of sensor 1304 are sensors relating to the status of client device 1302. For example, an accelerometer may sense whether computing device 1302 is in motion.

One or more sensors of sensors 1304 may be sensors relating to the status of image capture device 1310. For example, a gyroscope may sense whether image capture device 1310 is tilted, or a pixel evaluator indicating the value of pixels in the display at certain locations.

Local image analysis application 1322a comprises modules and instructions for conducting bounding box creation, segmentation mask generation, and pixel evaluation of the subject, bounding box or display boundaries. Local image analysis application 1322a is communicatively coupled to display 1306 to evaluate pixels rendered for projection.

Image capture application 1308 comprises instructions for receiving input from image capture device 1310 and transmitting a captured image to server device 1320. Image capture application 1308 may also provide prompts to the user while the user captures an image or video, and receives data from local image analysis application 1322a or remote image analysis application 1322b. For example, image capture application 1308 may provide an indication on display 1306 of whether a pixel value boundary condition is satisfied based on an output of local image analysis application 1322a. Server device 1320 may perform additional operations upon data received, such as storing in database 1324 or providing post-capture image analysis information back to image capture application 1308.

In some embodiments, local or remote image analysis application 1322a or 1322b are run on Core ML, as provided by iOS or Android equivalents; in some embodiments local or remote image analysis application 1322a or 1322b are run with open sourced libraries such as TensorFlow.

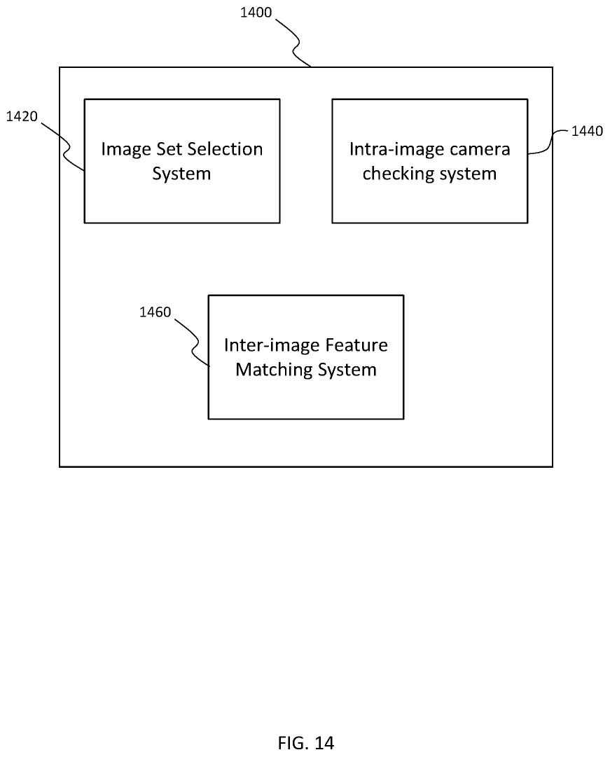

Described above are embodiments that may be referred to as intra-image checks. Intra image checks are those that satisfy desired parameters, e.g., framing an object within a display, for an instant image frame. FIG. 14 illustrates a block diagram of an inter-image parameter evaluation system 1400 inclusive of an image set selection system 1420, and inter-image feature matching system 1460 among other computing system components, such as intra-image camera checking system 1440. Image evaluations performed by inter-image parameter evaluation system 1400 analyze not only an instant frame's suitability for reconstruction, but also a plurality of image frames' relationship to other image frames. Inter-image parameter evaluation 1400 system may be configured to detect feature matches between two or more images, and generate an image set satisfying desired metrics (e.g., feature matches among images) as well as analyze image content of any one frame. Inter-image parameter evaluation system 1400 may operate as a specific type of image analysis application 1322a or 1322b as described with reference to FIG. 13, or in conjunction with or parallel to such components.

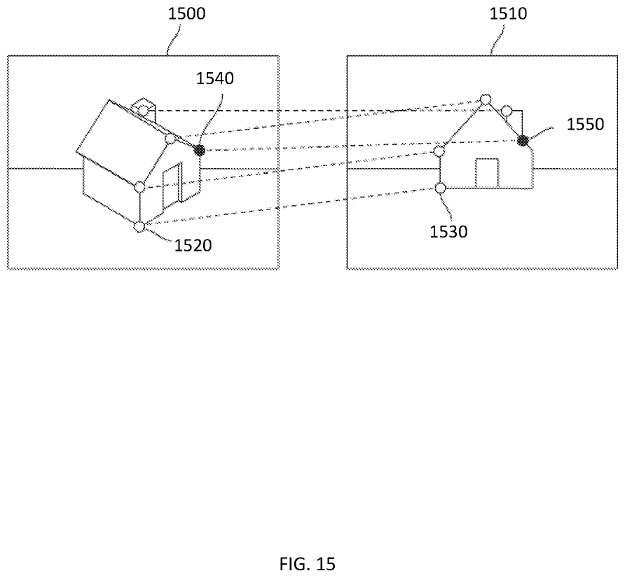

Referring to FIG. 15, in some examples the inter-image feature matching system 1460 of FIG. 14 is configured to detect features within image 1500, such as feature 1520 (e.g., a bottom left corner of a house) and feature 1540 (e.g., a right-side corner of the roof of the house). Likewise, in some embodiments, inter-image feature matching system 1460 is configured to detect features within image 1510, such as feature 1530 (e.g., a bottom left corner of the house) and feature 1550 (e.g., a bottom corner of a chimney located on the right side of the roof). Given the features detected in each of images 1500 and 1510, inter-image feature matching system 1460 can perform a feature matching technique that detects a correspondence between, for example, feature 1520 of image 1500 and feature 1530 of image 1510. Non-limiting examples of feature matching techniques include Brute-Force matching, FLANN (Fast Library for Approximate Nearest Neighbors) matching, local feature matching techniques (RoofSIFT-PCA), robust estimators (e.g., a Least Median of Squares estimator), and other suitable techniques. Detection, to include quality and quantity, of feature matches across images provides increased information for localization algorithms (for example, epipolar geometry) to improve accuracy by constraining the degrees of freedom camera poses may have.

In 3D reconstruction, additional image inputs provide additional scene information that can be used to either localize the cameras that captured the images or provide additional visual fidelity (e.g., textures) to a reconstructed subject of the images. Sparse collection of images for reconstruction are compact data packages for processing but may omit finer details of the subject or not be suitable for certain reconstruction algorithms (for example, insufficient feature matches between the sparse frames to effectively derive the camera position(s)). Increases in accurate or confident feature matches across images reduce the degrees of freedom in camera solutions, producing finer camera localization. For example, in FIG. 15 feature 1540 for the corner of a roof is incorrectly matched with feature 1550 for a component of a chimney. Additional image inputs between image 1500 and 1510 may have alleviated these false matches. High volume collection of images, such as a video feed or other high frame rate capture means may provide such additional detail like improved or increased feature matches among increased or improved inputs, or complement known reconstruction techniques; it will be apparent though, that in mobile device frameworks these larger data package inputs impede the production or transmission in a timeframe comparable with sparser collection.

In some embodiments, an inter-image parameter evaluation system 1400 analyzes feature matches to select image frames from a plurality of frames to reduce an aggregate image input into a subset (for example, a keyframe set), wherein each image of the subset comprises data consistent with or complementary to data with other images in the subset without introducing unnecessary redundancy of data. In some embodiments, this is carried out by communication from an image set selection system 1420 and inter-image feature matching system 1460. The consistent or complementary data can be used for a variety of tasks, such as localizing the associated cameras relative to one another, or facilitating user guidance for successive image capture. This technique can generate a dataset with desired characteristics for 3D reconstruction (e.g., more likely to comprise information for deriving camera positions due to consistent feature detection across images), though culling a dataset with superfluous or diminishing value relative to the remaining dataset may also occur in some examples. In other words, examples may include active selection of image frames (such as at time of capture), or active deletion of collected image frames. Aspects of images indicative of desired characteristics for 3D reconstruction include, in some embodiments, a quantity of feature matches or a quality of feature matches.

In some embodiments, inter-image parameter evaluation system 1400 evaluates a complete set of 2D images after an image capture session has terminated. For example, a native application running the inter-image parameter evaluation system 1400 can begin evaluating the collected images when the user has obtained views of the subject to be captured from substantially all perspectives (an inter-image parameter known as “loop closure”). Terminating the image capture session can include storing each captured image of the set of captured images and evaluating the set of captured images by the inter-image parameter evaluation system 1400 to determine which frames to select or populate a subset (e.g., keyframe set) with.

In some embodiments, the inter-image parameter evaluation system 1400 evaluates an instant frame concurrent with an image capture session and determines whether the instant frame satisfies a 3D reconstruction condition, such as inter-image parameters like feature matching relative to other frames captured or intra-image parameters like framing. This on-the-fly implementation progressively builds a dataset of qualified images (such as by assigning such image frames as a keyframe or uploading to a separate memory).

In some embodiments, the set of captured images is evaluated on a client device, such as a smartphone or other client device 1302 of FIG. 13 (i.e., in some examples client device 1302 is a smartphone though other computing systems or onboard devices are also client devices that may capture and process imagery). In some embodiments, the local image analysis application 1322a comprises at least some components of inter-image parameter evaluation system 1400. In some embodiments, the set of captured images (e.g., a keyframe set) is transmitted to a remote server for reconstructing the 3D model of the subject captured by the images. The remote server may be server device 1320 of FIG. 13, where remote image analysis application 1322b may comprise at least some components of inter-image parameter evaluation system 1400.

In some embodiments, an image set is generated from an image capture session by analyzing image frames and selecting keyframes from the analyzed image frame based on their 3D reconstruction applicability. 3D reconstruction applicability may refer to qualified or quantified feature matching across image frames; image frames that recognize a certain number or type of common features across image frames are eligible for selection as a keyframe. 3D reconstruction applicability may also refer to, non-exclusively, image content quality such as provided by intra-image camera checking system 1440.

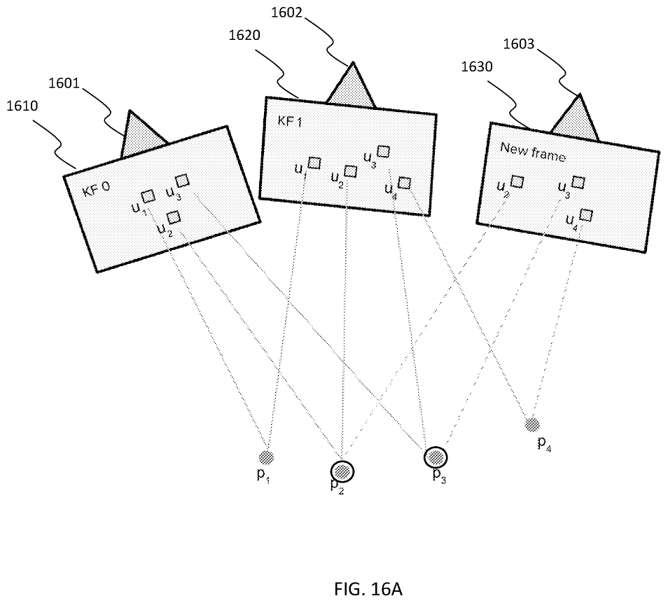

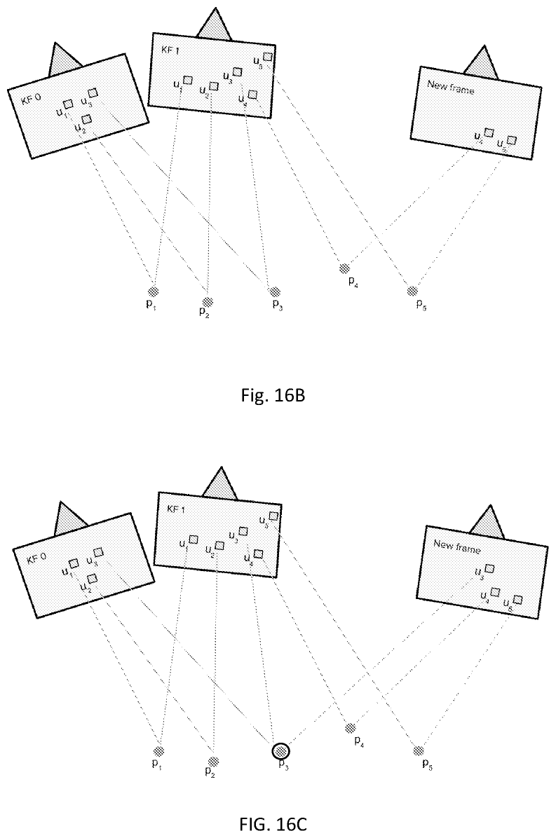

FIG. 16A illustrates keyframe selection according to some embodiments. An initial image frame 1610, or KF₀ associated with camera 1601, observes an environment populated with subjects having at least features p₁, p₂, p₃ and p₄. It should be noted that while FIG. 16A depicts image frame 1610 as KF₀, in some embodiments KF₀ is not a keyframe but an associate frame that may still populate a keyframe set and may be selected by intra-image camera checking system 1440. Such associate frame selection may be via segmentation mask or bounding box satisfaction of border or display boundary pixels or camera angle perspective scoring as described elsewhere in this disclosure.

Each of features p₁-p₄ may fall on a single subject (for example, a house to be reconstructed in 3D) or disparate subjects within the environment. As depicted, features p₁, p₂ and p₃ are within camera 1601 field of view. A second camera 1602 identifies at least three features in common with KF₀, as depicted these are p₁, p₂, and p₃. Second camera 1602 also observes new point p+.

In some embodiments, this recognition of common features with previous image frame KF₀ selects image frame 1620 as the next keyframe (or associate frame) for the keyframe set (as depicted, image frame 1620 is designated as KF₁).

In some embodiments, to ensure KF₁ is not simply a substantially similar image frame as KF₀, KF₁ must be a prescribed distance from KF₀, or satisfy a feature match condition. The prescribed distance may be validated according to a measurement from a device's IMU, dead reckoning, or augmented reality framework. In some examples, the prescribed distance is dependent upon scene depth, or the distance from the imaging device to the object being captured for reconstruction. As an imager gets closer to the object, lateral translation changes (those to the left or right in an orthogonal direction relative to a line from the imager to the object being captured) induce greater changes in information the imager views through its frustum. In some examples, such as indoor scene reconstruction with distance from an imager to the object measured in single digit meters, the prescribed distance is an order of magnitude lower than the imager-to-object distance. For example, when reconstructing an interior room wherein the imager is less than two meters from a wall of the indoor scene, a prescribed distance of 20 cm is required before the system will accept a subsequent associate frame or keyframe. For an outdoor scene, where the imager-to-object distance is greater than two meters the prescribed distance is equal to the imager-to-object distance. Imager-to-object distance may be determined from SLAM, time of flight sensors, or depth prediction models.

In some embodiments, the prescribed distance may be an angular distance such as rotation, though linear distance such as translation is preferred. While angular distance can introduce new scene data without translation between camera poses, triangulating features between the images and their camera positions is difficult. In some embodiments, a translation distance proxy is established by an angular relationship of points between camera positions. For example, if the angle subtended between a triangulated point and the two camera poses observing that point is above a threshold then the triangulation is considered reliable. In some embodiments, the threshold is at least two degrees. In some embodiments, a prescribed distance is satisfied when a sufficient number of reliable triangulated points are observed.

In some embodiments, the number of feature matches between eligible keyframes comprise a maximum so that image frame pairs are not substantially similar and new information is gradually obtained. Substantial similarity across image frames diminishes the value of an image set as it can increase the amount of data to be processed without providing incremental value for the set. For example, two image frames from substantially the same pose will have a large number of feature matches while not providing much additional value (such as new visual information) relative to the other.

In some embodiments, the number of feature matches is a minimum to ensure sufficient nexus with a previous frame to enable localization of the associated camera for reconstruction. In some embodiments, the associate image frames or keyframes (e.g., KF₁) must have at least eight feature matches with a previous associate frame of keyframe (e.g., KF₀), though for images with a known focal length as few as five feature matches is sufficient; in some embodiments a minimum of 100 feature matches is required, in some examples each feature match must also be a point triangulated in 3D space. In some embodiments, image pairs may have no more than 10,000 feature matches for keyframe selection; however, if a camera's pose as between images have changed beyond a threshold for rotation or translation then a maximum feature match limit is obviated as described further below.

FIG. 16A further depicts a new image frame 1630 viewing the scene from the pose of camera 1603. In some embodiments, features detected within new frame 1630 are compared to preceding keyframes or associate image frames (e.g., KF₀ and KF₁ as depicted) to determine whether an N-focal feature match criteria is met. In some embodiments, if an N-focal feature match criteria is met with respect to previous frames, new frame 1630 is selected as a keyframe. Though the disclosures herein may be applied for many numerical values for an N-focal feature, detailed discussion hereafter will refer to use of trifocal features, wherein N=3 in that a given feature may be mapped across three or more images. Skilled artisans will recognize the teachings of this disclosure apply similarly to N-focal features for matched features across 4 images, or 5 images, and so on. FIG. 16A depicts a trifocal feature match criteria: points p₂ and p₃ are trifocal features as they are viewable by at least image frames 1610, 1620, and 1630.

FIGS. 16B and 16C illustrate further feature matching scenarios. In FIG. 16B, though some feature matching occurs for the new frame (p₄ and p₅ is visible in KF₁ and the new frame), there are no features observed by all three image frames. As such, the new frame as depicted in FIG. 16B would not be selected as a keyframe for those embodiments with an N-focal criteria equal to or greater than three. In FIG. 16C, there is a single trifocal feature p₃ observed by the depicted image frames; the new frame here would be eligible for selection as a keyframe for the image set in those examples requiring a single trifocal feature for keyframe eligibility. As the number of trifocal features present in a frame increase, the more reliable the frame is for reconstruction as the additional trifocal features constrain the degrees of freedom of eligible poses of the camera and more precisely place the camera's estimated pose. As the number of trifocal features decrease, the potential for drift or other error in deriving the position of subsequent cameras increases, or multiple derived positions may satisfy the matched feature observation. In some examples, an image frame must comprise at least three trifocal features to be selected as a keyframe; in some examples, an image frame must comprise at least five trifocal features to be selected as a keyframe; in some examples, an image frame must comprise at least eight trifocal features to be selected as a keyframe.

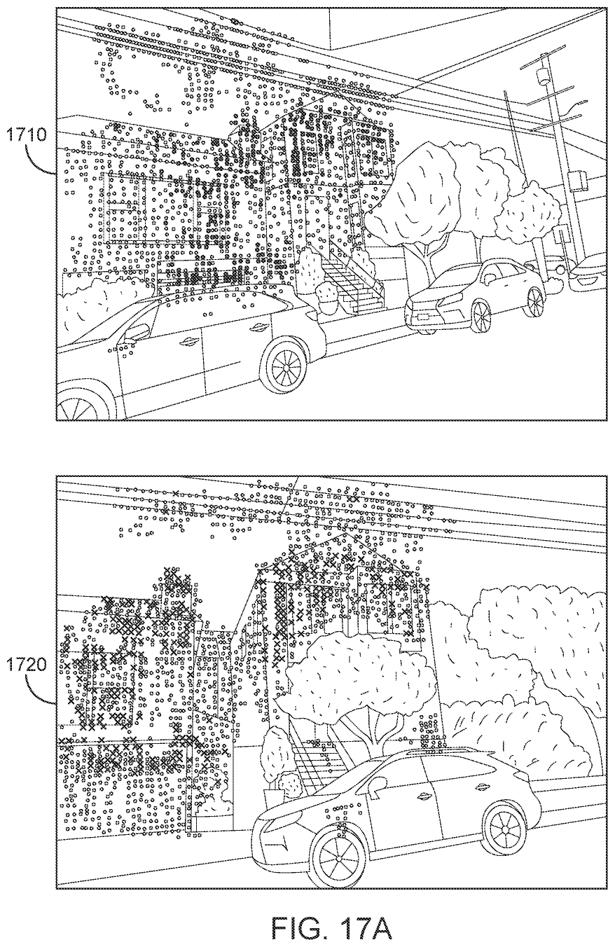

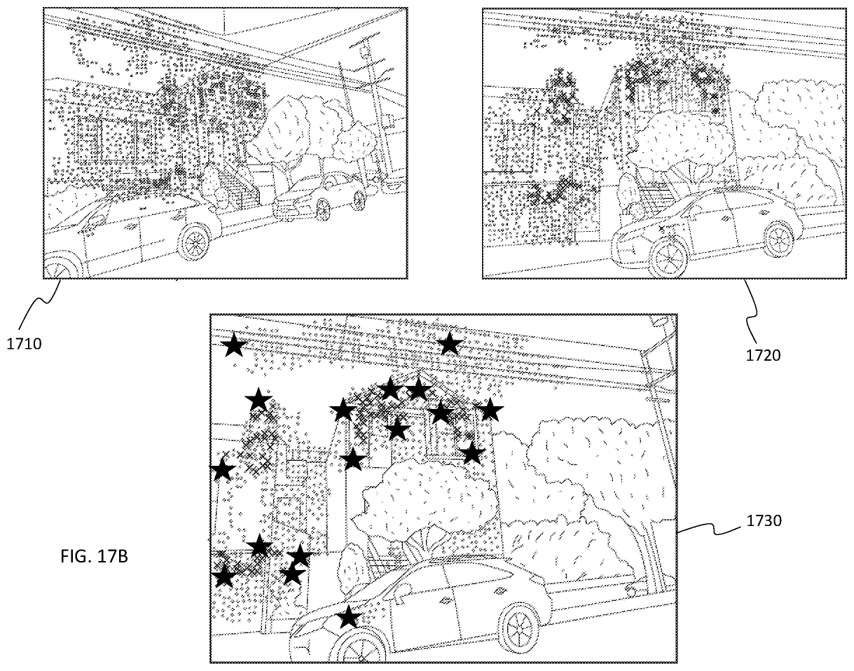

FIG. 17A illustrates experimental data for image frame selection in a keyframe set generation process according to some embodiments. Within element 1710, an initial image frame or associate frame or KF₀ as referred to above, a plurality of feature points are detected and shown as circular dots; for ease of illustration not all detected features are represented in element 1710. The image frame of element 1710 may be selected as a keyframe or an associate frame, in some embodiments the image frame of element 1710 is selected if it satisfies an intra-image parameter check, such as boundary pixel analysis as described elsewhere in this disclosure. Element 1720 illustrates a subsequent image frame comprising a number of detected features similarly shown as circular dots (again less than all detected features so as not to crowd the depiction in element 1720). Element 1720 is one of a plurality of image frames captured separately from the image frame of element 1710. Separate capture of element 1720 indicates it may be captured during a same capture session from the same device as the one that captured element 1710 simply at a different time (such as subsequent to), or may be captured by a separate device at a separate time from that of element 1710.

FIG. 17A further shows feature matches between image frames of elements 1710 and 1720, such feature matches are depicted as X's in element 1720. In some examples, a feature match is one that satisfies a confidence criteria according to the respective algorithm, such that while common features may be detected in element 1720, not all common features are actually matched. Though FIG. 17A depicts feature detection and feature matching, in practice these may be backend constructs and not actually displayed during operation.

Feature matches above a first threshold and below a second threshold ensure the subsequent image frame (e.g., element 1720) is sufficiently linked to another image frame (e.g., 1710) while still providing additional scene information (i.e., does not represent superfluous or redundant information). In some embodiments, the first threshold for the minimum number of feature matches, or reliably triangulated points, between an initial frame and a next associate frame or candidate frame is 100. In some embodiments, the maximum number of feature matches is 10,000. In some embodiments the second threshold (the maximum feature match criteria) is replaced with a prescribed translation distance from the initial image frame as explained above. In some embodiments, if this prescribed translation distance criteria is met, a maximum feature match criteria is obviated. In other words, if camera poses are known to be sufficiently separated by distance (angular change by rotation or linear change by translation), increased feature matches are not capped by the system. For small pose changes, feature matching maximums are imposed to ensure new image frames comprise new information to facilitate reconstruction.

FIG. 17B illustrates experimental data for analyzing a second plurality of image frames for keyframe selection, according to some embodiments. With selection of element 1710 and 1720 as frames for building a keyframe set of images, additional captured image frames are analyzed to continue identifying and extracting image frames as keyframes. As depicted, the image frame as in element 1730 is captured (either as part of a similar capture session as elements 1710 and 1720 but subsequent to those captures, or separately from such capture session that generated elements 1710 or 1720). Each of elements 1710, 1720, and 1730 are analyzed together to recognize the presence of N-focal features. As illustrated in FIG. 17B, a trifocal feature criteria is applied, resulting in a plurality of trifocal features depicted as black stars rendered in element 1730 (note the actual number of trifocal features has been reduced for ease of depiction). Trifocal features above a first threshold and below a second threshold identify at least the image frame associated with element 1730 as a keyframe. In some embodiments, presence of a single trifocal feature designates the image frame of element 1730 as a keyframe. In some embodiments, the presence of at least three trifocal features designates the image frame of element 1730 as a keyframe; in some embodiments, the presence of at least five trifocal features designates the image frame of element 1730 as a keyframe; in some embodiments, the presence of at least eight trifocal feature designates the image frame of element 1730 as a keyframe. Elements 1710 and 1720 may be designated as keyframes, or may be designated as associate frames within an image set comprising keyframe 1730, such that element 1730 is the first formal keyframe of the set.

Notably, in some examples feature matches and trifocal features associated with subjects other than the target of interest may be used to qualify an image frame as an associate frame or as a keyframe. FIG. 17B depicts experimental data for collecting images to reconstruct a house, but still makes use of feature matches and trifocal features observed along power lines and the car of the scene. These features are useful for deriving camera poses despite not comprising information exclusively for the target subject. In some examples, secondary considerations or secondary processing focuses feature detection or feature matching or trifocal feature detection exclusively on the target subject (i.e., trifocal features that fall upon the car would not be part of a quantification of trifocal features in reconstructing a house within the image set).

In some examples, associate frame or keyframe selection is further conditioned on semantic segmentation of a new frame, or other intra-image checks such as proper framing or camera angle perspective. Similar to intra-image checks discussed previously, classification of observed pixels to ensure structural elements of the subject are appropriately observed further influences an image frame's selection as a keyframe. As illustrated in FIGS. 17A and 17B, feature matches may be made to any feature of within the image, regardless of content that feature is associated with. For example, features in element 1710 that fall along the power line are matched in 1720 or form the basis of trifocal features in 1730, even though the object of interest for reconstruction is the residential building in the image frames. In some examples, a segmentation mask for the object of interest is applied to the image frame and only features and matches or trifocal features within the segmentation mask of the object of interest are evaluated.

In some embodiments, a keyframe set is such a dense collection of features of a subject that a point cloud may be derived from the data set of trifocal features or triangulated feature matches.

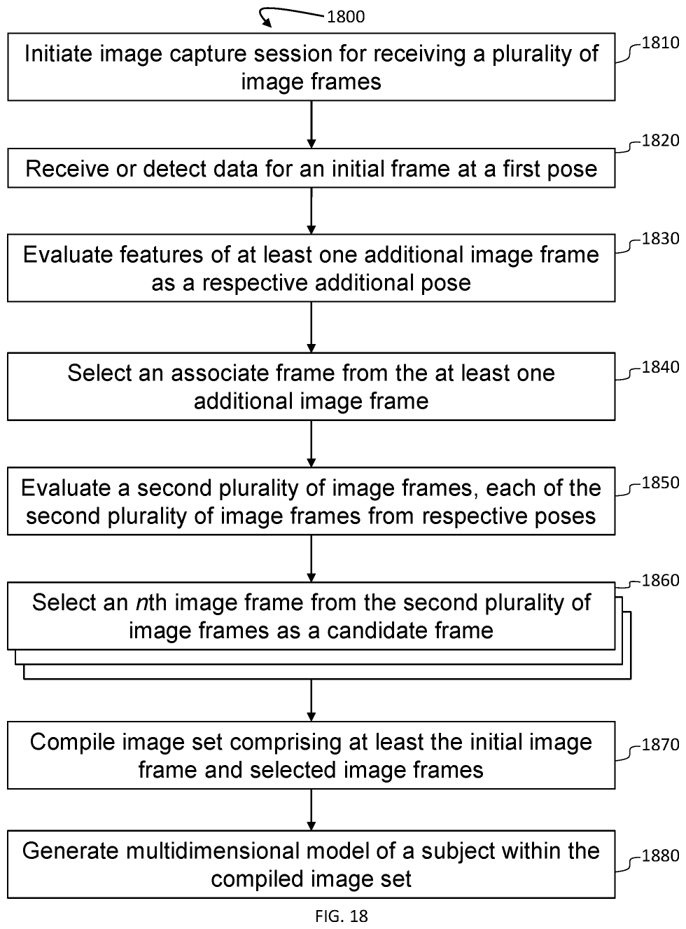

FIG. 18 illustrates method 1800 for generating a dataset comprising keyframes. At step 1810, a native application on a user device, such as a smartphone or other image capture platform or device, initiates a capture session. The capture session enables images of a target subject, for example a house, to be collected from a variety of angles by the image capture device. In some embodiments, the capture session enables depth collection from an active sensing device, such as LiDAR. Discussion hereafter will be made with particular reference to visual image data. Data, such as images' visual data, captured during a session can be processed locally or uploaded to remote servers for processing. In some embodiments, processing the captured images includes identifying a set of related or associated images, localizing the camera pose for each associated image frame, or reconstructing multidimensional representations or models of at least one target subject within the captured images.

At step 1820 data is received from a first pose (e.g., an initial image frame). This may be a first 2D image or depth data or point cloud data from a LiDAR pulse, and may be from a first camera pose. In some embodiments, the first image capture is guided using the intra-image parameter checks as described above and performed by intra-image camera checking system 1440. Such intra-image parameters include framing guidance for aligning a subject of interest within a display's borders. In some embodiments, the first 2D image is responsively captured based on user action; in some embodiments, the first 2D image is automatically captured by satisfying an intra-image camera checking parameter (e.g., segmented pixels of the subject of interest classification are sufficiently within the display's borders). The first captured 2D image is further analyzed to detect features within the image. In some embodiments, the first captured 2D image is designated as a keyframe; in some embodiments the first captured 2D image is designated as an associate frame.

At step 1830, additional image frames are analyzed and compared to the data from step 1820. The additional image frames may come from the same user device as it continues to collect image frames as part of a first plurality of image frame capture or reception; the additional image frames may also come from a completely separate capture session or from a separate image capture platform's capture session of the subject. In some examples, these additional image frames are part of a first plurality of additional image frames. Image capture techniques for the additional image frames in the first plurality of additional image frames include video capture or additional discrete image frames. Video capture indicates that image frames are recorded regardless of a capture action (user action or automatic capture based on condition satisfaction). In some embodiments, a video capture records image frames at a rate of three frames per second. Discrete image frame capture indicates that only a single frame is recorded per capture action. A capture action may be user action or automatic capture based on condition satisfaction, such as intra-image camera checking or feature matching or N-focal criteria satisfaction as part of inter-image parameter checks. In some embodiments, each of the additional image frames from this set of a first plurality of separate image frames comes from an image capture platform (such as a camera) having a respective pose relative to the subject being captured. Each such image frame is evaluated. In some embodiments, evaluation includes detecting features within each image frame, evaluating the number of features matches in common with a prior image frame (e.g., the first captured 2D image from step 1820), or determining a distance between the first captured 2D image and each additional image frame from the first plurality of separate image frames.

At 1840, at least one of the additional image frames (to the extent there is more than one as from a first plurality of image frames) is selected. In some embodiments, an image frame is selected if it meets a minimum number of feature matches with the first captured 2D image; in some embodiments an image frame is selected if it does not comprise more than a maximum number of feature matches with the first captured 2D image. In some embodiments an image frame is selected if the respective camera pose for the additional image is beyond a camera distance from the camera pose of the initial image. In some embodiments the camera distance is a translation distance from the first captured 2D image; in some embodiments the camera distance is a rotation distance from the first captured 2D image. A selected image frame is one that maintains a relationship to visual data of a prior frame (e.g., the first captured 2D image) while still comprising new visual data of the scene as compared to the prior frame. Notably, in some embodiments features matches and relationship to visual data across the image frames is measured against scene data, and not solely against visual data of a subject of interest within a scene. In that regard, an image frame may be selected even though it comprises little to no visual information of the subject of interest in the first captured 2D image. In some embodiments, the selected image frame is designated as a keyframe; in some embodiments the selected image frame is selected as an associate frame.

At 1850 additional data is received and evaluated, such as by a second plurality of image frames. The additional data received may generate more than one candidate frame eligible for keyframe selection, meaning more than one frame may satisfy at least one parameter for selection (such as feature detection). The additional data may be from a second plurality of separate image frames such as captured from the same image capture device during a same capture session, or from a separate capture device or separate capture session. Evaluation of the second plurality of images may include evaluation of any additional received image frames as well as, or against, the initial frame, other associate frames, other candidate frames, or other keyframes. Each received separate image frame of this second plurality of frames is evaluated to detect the presence of feature matches relative to the image frame data from step 1840. Image frames that satisfy a matching criteria with the frame selected at step 1840 may be selected as eligible or candidate frames. Matching criteria may be feature matches above a first threshold (e.g., greater than 100) or below a second threshold (e.g., fewer than 10,000), or beyond a rotation or translation distance.

In some embodiments, evaluated data from the second plurality of image frames is analyzed at 1860 to select a keyframe or at least one additional candidate frame that may be designated as a keyframe. Image frames selected from step 1850 are analyzed with additional image frames, such as the data from steps 1820 and 1840, to determine the presence of N-focal features across multiple frames to identify keyframes within the second plurality of separate image frames. Identified frames with at least one, three, five or eight N-focal features may be selected as a keyframe or candidate frame.

Selection of a keyframe at 1860 may further include selecting or designating the image frames from 1820 and 1840 as keyframes. In other words, to the extent a keyframe is defined by the presence of N-focal features, the image frames from 1820 and 1840 may not qualify at the time of capture as an insufficient number of frames have been collected to satisfy a certain N-focal criteria. Step 1860 may continue for additional image frames or plurality of image frames, such as additional images captured while circumventing the target subject to gather additional data from additional poses, to generate a complete set of keyframes for the subject of interest. At step 1870, each frame selected as a keyframe, and the image frames from step 1820 and 1840 if not already selected as keyframes, are compiled into a keyframe image set.

In some examples, a multidimensional model for a subject of interest within the images is generated based on the compiled keyframe image set at 1880. In some examples, the multidimensional model is a 3D model of the subject of interest, the physical structure or scene such as the exterior of a building object; in some examples, the multidimensional model is a 2D model such as a floorplan of an interior of a building object. In some embodiments, this includes deriving the camera pose based on each keyframe, or reprojecting select geometry the image frame at the solved camera positions into 3D space. In some embodiments the multidimensional model is a geometric reconstruction. In some embodiments the multidimensional model is a point cloud.

In some embodiments the multidimensional model is a mesh applied to a point cloud. The feature point relationship between the keyframes enables camera localization solutions to generate a camera pose for each keyframe and reconstruct the geometry from the image data in a 3D coordinate system shared by all keyframe cameras, or place points extracted from common images in that 3D coordinate system as a point in a point cloud.

While FIG. 18 illustrates an exemplary method for generating a keyframe set, in some examples a plurality of keyframes or associate frames or candidate frames are already identified and a system need only initiate additional keyframe generation at step 1850 and build upon such pre-established reference frames using additional unique images against the reference image frames.

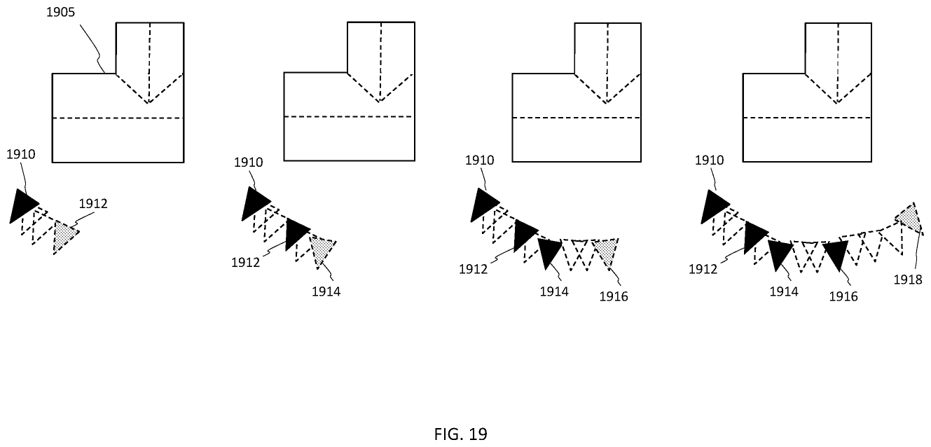

FIG. 19 illustrates a top plan view of a structure 1905 composed of an L-shaped outline from adjoining roof facets; FIG. 19 further illustrates a plurality of camera poses about structure 1905 as it is being imaged for generating a 3D model. An initial image is taken from camera position 1910, which may be an associate frame or a KF₀ as described above. Image frame analysis continues for camera positions after 1910 for each additional received, accessed or captured image until an image frame is identified that satisfies feature matching criteria or distance criteria. As illustrated in FIG. 19, the image frame from camera pose 1912 satisfies the evaluation (e.g., by either satisfying the feature matching or prescribed distance or both), and the image frame is accordingly designated as an associate frame or as a keyframe (e.g., KF₁). Image capture or image access or reception continues and analysis of frames subsequent to position 1912 is conducted to identify images with feature matches with the image frame at camera position 1912 as well as N-focal matches with the image frames at camera positions 1910 and 1912. In this way, the image frame from camera position 1912 is selected according to a first selection criteria (feature matches or prescribed distance), and subsequent image frames are selected according to a second criteria (the addition of the N-focal features requirement). As depicted, two camera positions later at 1914 an image frame satisfies the criteria, and is selected as a keyframe. This process continues under a “first-to-satisfy” protocol to produce keyframes from camera positions 1916 and 1918.

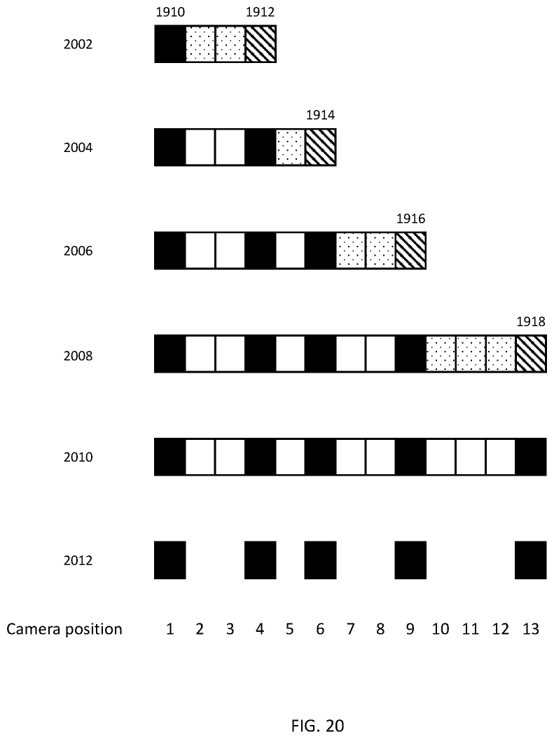

FIG. 20 illustrates a frame reel (also referred to as a “frame track” or “image track” or simply “track”) generation associated with camera positions during the capture session of FIG. 19. Frame track 2002 illustrates capture of an image from camera position 1910, and then the image capture from the subsequent three camera positions. The first image to satisfy the selection criteria is identified from camera position 1912. This selection will in turn influence what the next keyframe will be (the next keyframe must satisfy feature matches with 1912 and N-focal matches with other selected frames). Track 2004 includes previous track information and indicates such keyframe satisfaction from position 1914, which in turn will influence the next keyframe selection from position 1916 as in track 2006 and the image from position 1918 indicated in track 2008 and so on. FIG. 20 depicts how an image frame from position 1918 is dependent on each of the preceding selected frames and camera positions. Also depicted in FIG. 20 is cumulative track (or cumulative frame reel) 2010; as depicted over the course of image analyses over thirteen camera positions, five images were selected as part of the keyframe selection.

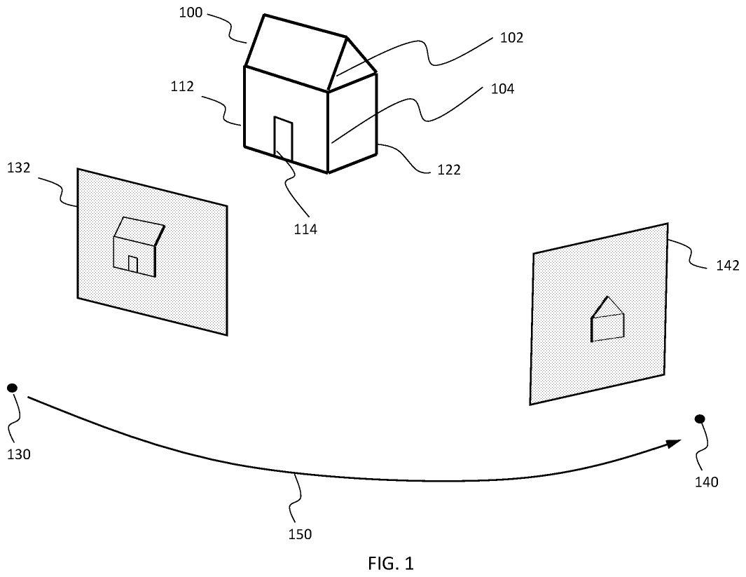

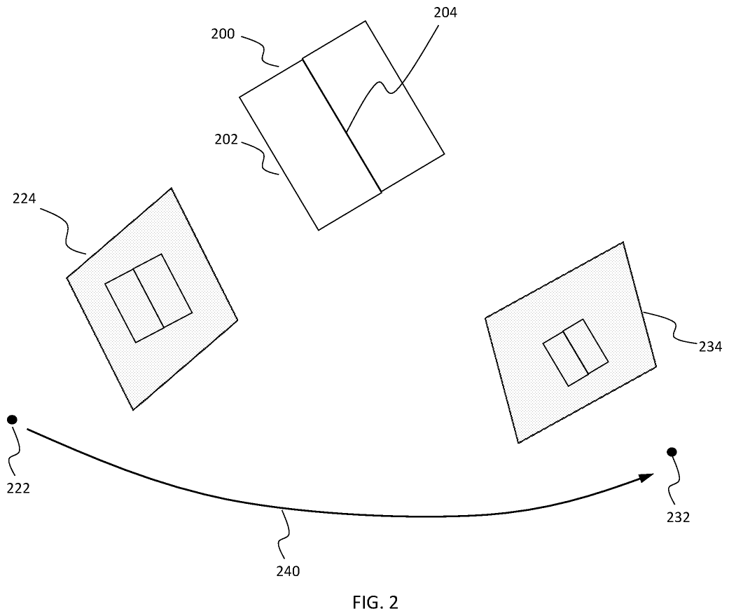

Track 2010 is likely to possess the images with feature matches necessary for deriving the camera poses about structure 1905 with higher confidence than as with the wide baseline captures initially introduced as with FIG. 1 and the limited feature matches that method enables. In some examples, the selected frames (initial frames, associated frames, keyframes, etc.) are extracted from track 2010 to create keyframe set, or image subset, 2012 comprising a reduced number of images as compared to a frame reel (or track) with image frames that will not be used such as the white block image frames for associated camera positions as in track (or frame reel) 2010. In some examples, a failed track is identified when a successive number of image frames do not produce feature matches with a previous image frame. In some examples, a failed track occurs when five or more image frames are collected that do not match with other collected image frames.

It will be appreciated that track 2010, or even track 2012, is also likely to increase the number of images introduced into a computer vision pipeline relative to a wide baseline sparse collection. Some examples provide additional techniques to manage the expected larger data packet size.

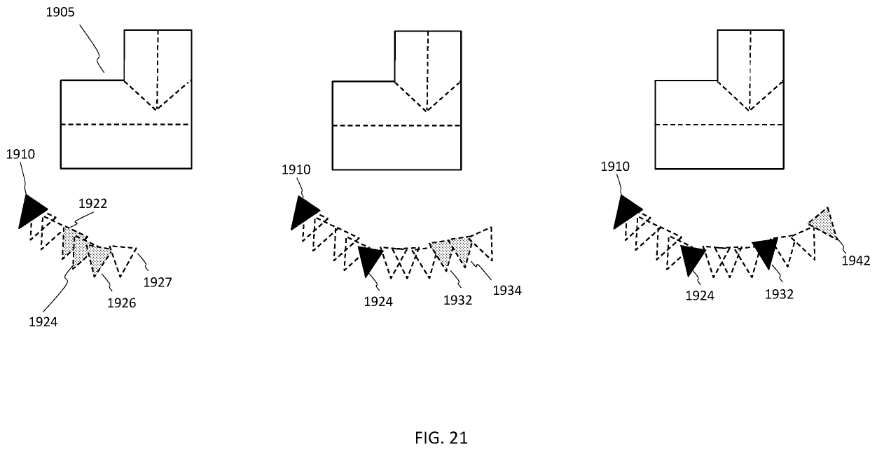

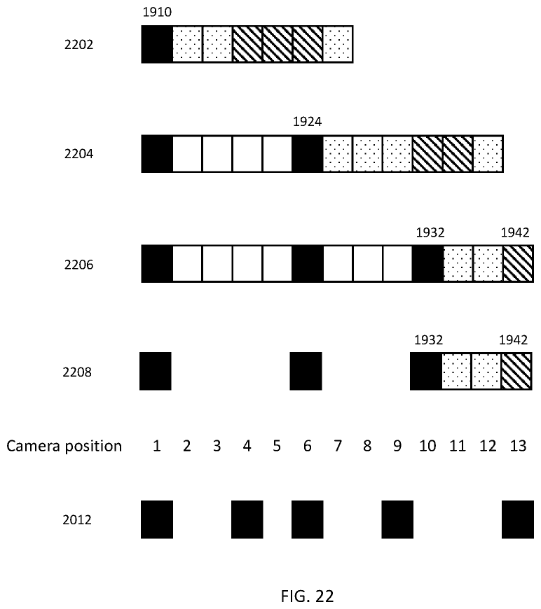

FIG. 21 illustrates a deferred keyframe selection process. This process initially resembles the keyframe identification and selection process as in FIG. 19, and an image of structure 1905 is taken from camera position 1910 (as similarly shown in track 2202 of FIG. 22). From there, rather than accept the first eligible image frame (e.g., the frame at camera position 4 or 1912 described above), a plurality of image frames that satisfies the selection criteria are identified from camera positions 1922, 1924, and 1926. These image frames are marked as “candidate frames” for secondary processing. Candidate frames may begin to be collected, or pooled, starting from camera position 1922 and continue being collected until the data from a resultant image frame or camera position no longer satisfies the selection requirement with the image from camera position 1910; camera position 1927 depicts such a non-qualifying camera position (e.g., the image frame at camera position 1927 no longer has sufficient feature matches with the image frame from camera position 1910).

In some examples, when a successive image does not satisfy the keyframe selection criteria, the candidate frame pool is closed. In some embodiments, when multiple successive images do not satisfy the keyframe selection criteria, the candidate frame pool is closed. This multiple successive rule reduces the instance that additional candidate frames could follow and pooling is not interrupted by a noisy frame, or a frame with unique occlusions, etc. In some examples, a quantitative limit is imposed on the number of candidate frames in a given pool. In some examples the maximum size of the candidate frame pool is five images.

When a candidate frame pool is closed, each candidate frame is analyzed and processed for secondary considerations. Secondary considerations may include but are not limited to intra-image parameters (such as framing quality and how well the object fits within the display borders, or angular perspective scoring), highest quantity of feature matches, diversity of feature matches (matches of features are distributed across the image or subject to be reconstructed), or semantic diversity within a particular image. Secondary considerations may also include image quality, such as rejecting images with blur (or favoring images with reduced or no blur). Secondary considerations may also include selecting the candidate frame with the highest number of feature matches with a previously selected frame (e.g., the image associated with position 1910). As depicted in FIG. 21, the image associated with camera position 1924 is selected from the pool of candidate frames. Candidate frame selection begins again with identification of candidates at positions 1932 and 1934. As depicted in FIG. 21 the selection of the image associated with camera position 1924 in turn influences the next identification of candidate frames until a non-qualifying position is reached as shown in track 2204 of FIG. 22. From the candidate frames of track 2204, the image frame at position 1932 (camera position 10) is chosen, leading to pooling of at least the image frame at 1942 for the next candidate frame selection analysis as shown in track 2206.

In some examples, the selected frames (initial frames, associated frames, keyframes, etc.) are extracted from track 2206 to create keyframe set, or image subset, 2208 comprising a reduced number of images as compared to a frame reel (or track) with image frames that will not be used such as the white block image frames for associated camera positions as in track (or frame reel) 2206.

For illustrative and comparative purposes, keyframe set 2012 is also depicted in FIG. 22 to demonstrate the reduced data packet size that deferred keyframe selection may enable. Whereas the frame reel of FIG. 20 produced five keyframes by the time camera position 13 was reached (see keyframe set 2012), deferred selection only affirmatively identifies three in keyframe set 2208 (the image at position 1942 is a candidate frame only and not yet a selected keyframe). This reduction in data package size facilitates faster processing due to less images to process, and faster transmission of the input images themselves to remote processors if needed; this occurs while still maintaining the quality of the data as the feature matching rules are preserved despite the smaller image payload.

In some examples, an initial frame is selected from a plurality of frames without regard to status as a first captured frame or temporal or sequential ordering of received frames. Associate frame or candidate frame or keyframe selection for the plurality of frames occurs based on this sequence-independent frame. A sequence-independent frame may be selected among a plurality of input frames, such as a video stream that captures a plurality of images for subsequent processing. Aerial imagery collection is one such means for gathering sequences of image frames wherein an initial frame may be of limited value compared to the remaining image frame; for example, an aircraft carrying an image capture device may fly over an area of interest and collect a large amount of image frames of the area beneath the aircraft or drone conducting the capture without first orienting to a particular subject or satisfying an intra-image parameter check. From the large image set collected by such aerial capture, a frame capturing a particular subject (such as a house) can be selected and a series of associated frames bundled with such sequence-independent frame based on feature matching or N-focal features as described throughout.

Sequence-independent selection may be user driven, in that a user selects from among a plurality of images, or may be automated. Automated selection in some examples includes geolocation (e.g., selecting an image with a center closest to a given GPS location or address), or selecting a photo associated with an intra-image parameter condition (e.g., the target of interest occupies the highest proportion of a display without extending past the display's borders), or satisfies a camera angle parameter as described below.

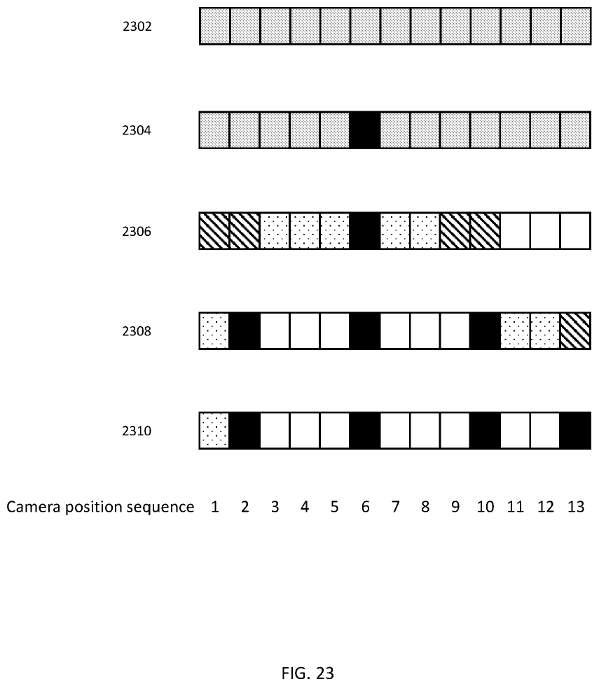

In FIG. 23, a plurality of frames is collected to create frame reel 2302 (each collected frame represented in grayscale). Within this frame reel, a sequence-independent frame is selected for camera sequence position 6, though this is merely for illustrative purposes and selection of the initial frame of the frame reel (e.g., camera sequence position 1) is possible in some examples dependent upon selection criteria. Frame reel 2304 illustrates this sequence-independent frame selection, in turn the adjoining frames to camera sequence position 6 may be analyzed for feature matches with the image frame at camera sequence position 6 to identify associate frames, candidate frames or keyframes as discussed throughout this disclosure.

Frame reel 2306 illustrates the image frames at camera sequence positions 3, 4, 5, 7, and 8 do not comprise sufficient feature matching with the sequence-independent frame at camera position 6; the image frames at camera sequence positions 1, 2, 9, and 10 do possess feature matches consistent with identifying them as associate frames, candidate frames or keyframes. Frame reel 2308 illustrates selection of the images frames at camera sequence positions 2 and 10 for their relation to the sequence-independent frame at camera sequence position 6, which in turn initiates analysis of their adjoining image frames for further selection for a keyframe set. An illustrative frame reel 2310 results from the sequence-independent frame, wherein at least the image frames at camera sequence positions 2, 6, 10, and 13 are selected for a keyframe set.

While the sequence-independent frame protocol described in relation to FIG. 23 illustrate frame analysis in two directions (images from camera positions before and after camera sequence position 6 are analyzed), in some examples the analysis occurs in a single direction. For example, if an object of interest only appears in images before or after a certain camera sequence position, image analysis does not need to proceed in both sequence directions.

While the examples and illustrations above indicate specific frame selection, proximate frames to an identified frame may be selected as well, either in addition to or to the exclusion of a selected frame. In some examples, a proximate frame is an image immediately preceding or following a selected frame or frame that satisfies the selection criteria. In some examples, a proximate frame is an image within five frames immediately before or after a selected frame. Proximate frame selection permits potential disparate focal lengths to add scene information, introduce minor stereo views for the scene, or provide alternative context for a selected frame.

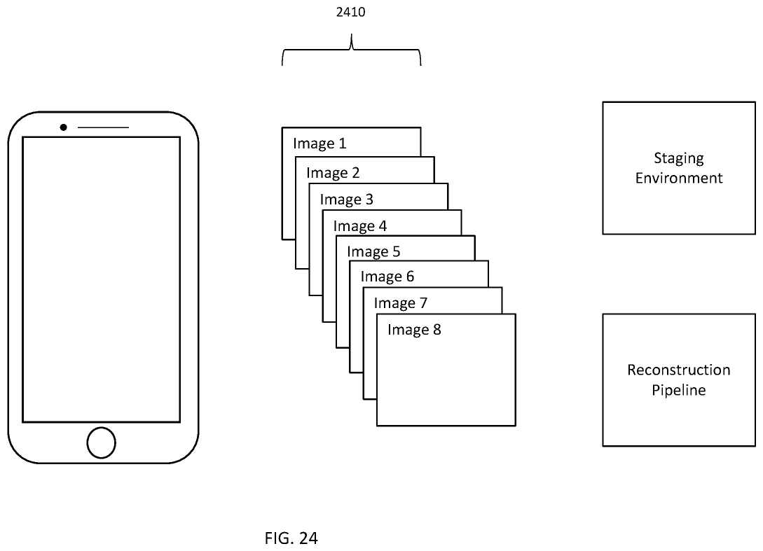

An illustrative data packet for sparse image collection, such as from a smartphone, is depicted in FIG. 24. A number of images are collected by the smartphone, such as by circumnavigating an object to be reconstructed in 3D, and aggregated in a common data packet 2410. In some examples, eight images are collected as part of a sparse collection. The data packet may then be submitted to a reconstruction pipeline, which may be local on an imaging device such as the smartphone or located on remote servers. In some examples, the data packet 2410 is stored in a staging environment in addition to, or prior to, submission to the reconstruction pipeline.

Delivery of a singular data packet to a staging environment or reconstruction pipeline as an aggregate data envelope ensures packet cohesion. Each image is deemed associated with the other images of the collection by virtue of inclusion in the singular packet. Data packets may be numbered or associated with other attributes, and such identifiers tagged to all constituent datum within the packet on an hierarchical basis. For example, data packet 2410 may be tagged with a location, and each of images 1 through 8 will be accordingly associated or similarly tagged with that location or proximity to that geographic location (e.g., for residential buildings, within 100 meters is geographic proximity). This singular packeting can reduce disassociation of data due to incongruity of other attributes. For example, and referring to aerial image collection as an example use case, if a first image is collected from a first location and a second image of the same target object from a second location, aircraft speeds will impart significant changes in geographic location of the imager between the two images or the captured subject's appearance or location within images, and associating data within any one image with data within any other image is less intuitive and becomes more complex if not structured as part of a common data packet at time of collection.

As data packet 2410 increases in size, such as by increased images within the data packet or increased resolution of any one image within the packet, transmission of the larger data packet to a staging environment or reconstruction pipeline becomes more difficult. If the reconstruction pipeline is to be performed locally on device, additional computing resources must be allocated to process the larger data packet.

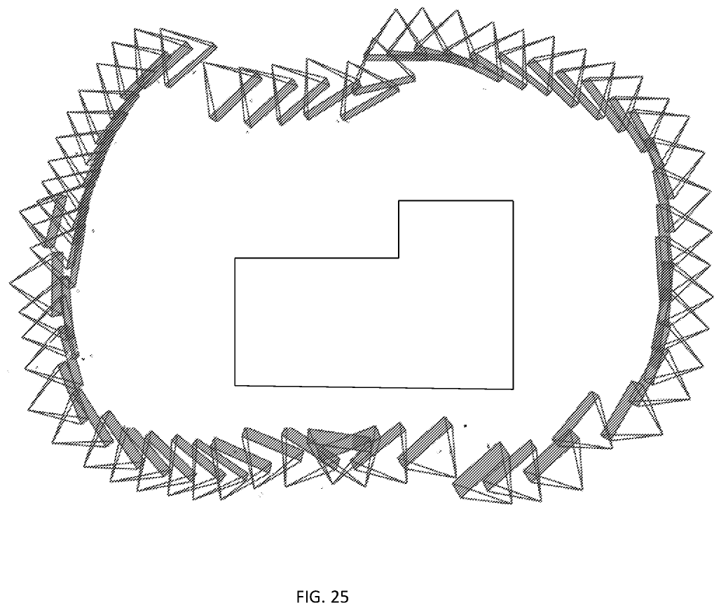

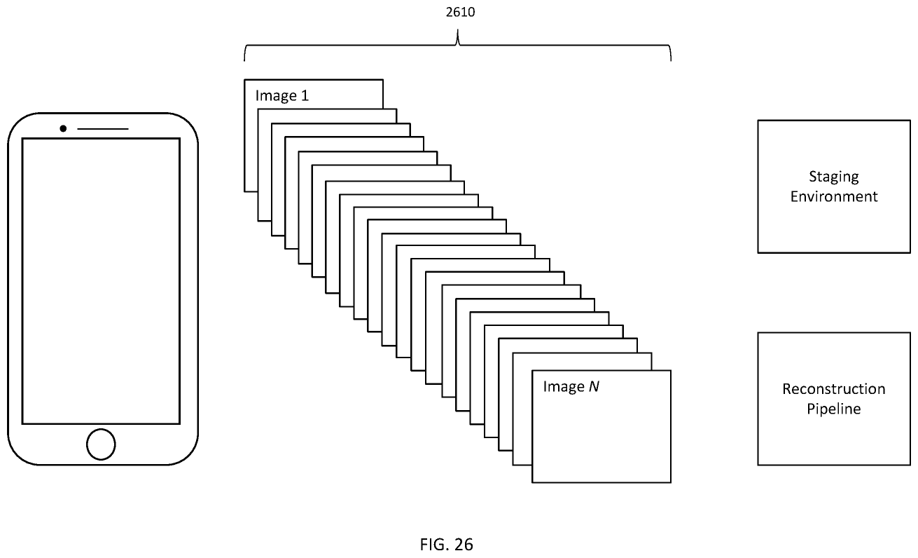

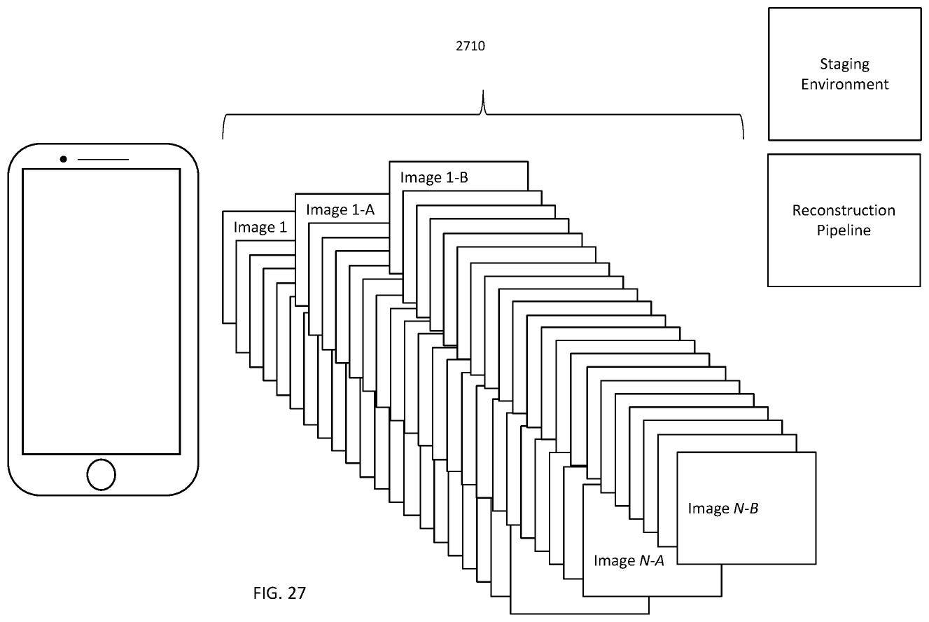

FIG. 25 illustrates a hypothetical dense capture solution, wherein instead of the sparse images collected about a structure, a higher volume of images as produced by feature matching criteria or keyframe selection produces a larger data packet such as 2610 of FIG. 26. In some examples, image capture is conducted across multiple platforms. For example, a user may conduct portions of image capture using a smartphone and then other portions with the aid of a drone or tablet computer. The resultant image sets are now even larger as shown in FIG. 27 with image set 2710, which augments a smartphone capture (e.g., the set associated with Image 1 in FIG. 27) with a track beginning with Image 1-A from a new platform (e.g., a drone), or track beginning with Image 1-B from another platform (e.g., a tablet device). Transmission difficulties, or reconstruction processing times of the sparse image set 2410 are now far worse with the expanded captures of image set 2610 or 2710, despite the increased value their additional images otherwise provide for reconstruction.

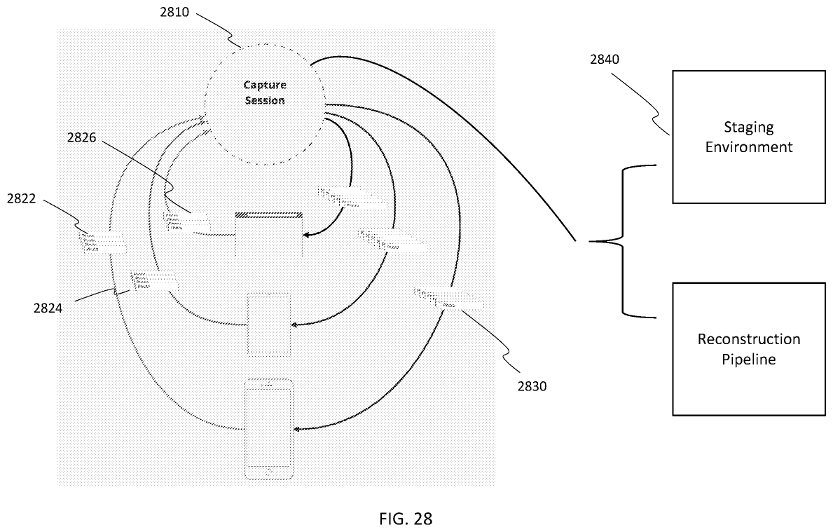

In some examples, the increased data packet size is addressed with an intermediate capture session upload. FIG. 28 illustrates initiating an intermediate transmission capture session 2810 to progressively receive captured images. In some examples, as an imager (e.g., smartphone, drone, or aircraft otherwise) captures an image, the single image is immediately transmitted to the capture session 2810 rather than aggregating with other images (such as on device) before transmission. In some examples, the capture session 2810 is the staging environment 2840; in some examples, capture session 2810 is distinct from staging environment 2840.

Multiple imaging platforms, such as a smartphone producing images 2822, a tablet producing images 2824, or a drone producing images 2826 may access the capture session 2810 to progressively upload one or more images as they are captured from the respective imaging device. By transmitting to capture session 2810, the benefits of singular packet aggregating are maintained as the capture session aggregates the images, with device computing constraints and transmission bandwidth limitations for larger packets mitigated.

In some examples, capture session 2810 may deliver images received by other devices to a respective image capture device associated with such capture. For example, as images 2822 are uploaded to capture session 2810 by smartphone, images 2824 captured by a tablet device are pushed to the smartphone via downlink 2830. This leverages additional images for any one image capture device, such as providing additional associate frames or candidate frames or keyframes for that device to incorporate for additional image analysis and frame reel generation. In some examples, the downlink 2830 enables contemporaneous access to images associated with capture session 2810. In some examples, the downlink provides asynchronous access to images associated with capture session 2810. In other words, for asynchronous access, tablet images 2824 may be captured a first time, and later at a second time as smartphone images 2822 are captured and uploaded into accessed captured session 2810 tablet images 2824 are provided to the smartphone via downlink 2830 to provide additional images and inputs for image analysis.

In some examples, single images are uploaded by an image capture device to capture session 2810. As each image is received, it may be processed such as for keyframe viability or image check quality (such as confirming the image received is actually a target object to be reconstructed). In some examples, as each image is received it is directed to a staging environment or reconstruction pipeline. In some examples, the incremental build of the data set permits initial reconstruction tasks such as feature matching or camera pose solution to occur even as additional images of the target object are still being captured, thereby reducing perceived reconstruction time. In some examples, concurrent capture by additional devices may all progressively upload to capture session 2810.

In some examples, images are transmitted from an imager after an initial criteria is met. In some examples, once an image is selected as a keyframe it is transmitted to capture session 2810. In this way, some image processing and feature matching occurs on device. In some examples, an image is transmitted to capture session 2810 and is also retained on device. Immediate transmission enables early checks such as object verification, while local retention permits a particular image to guide or verify subsequent images suitability such as for keyframe selection.

In some examples, the data received at capture session 2810 is forwarded to staging environment 2840 and aggregated with additional capture session data packets with common attributes. For example, a capture session tagged for a particular location at time x may be combined with a data packet from a separate capture session for that location as from a capture session at time y. In this way, asynchronous data profiles may be accumulated.

Referring back to FIG. 16B, incrementally captured frames such as the new frame of FIG. 16B may have insufficient trifocal matches with the previous frames (e.g., associated frames, candidate frames or keyframes; KF₀ and KF₁ are illustrative in FIG. 16B) for several reasons. The camera system may have moved too far relative to a previous keyframe, or too quickly, with no intermediate frames or images in between. For example, system latency or runtime of a feature matching protocol did not identify enough matches in the runtime before the new frame was presented, or images in between KF₁ and the new frame were rejected for exceeding the number of matches (such frames were deemed superfluous for providing no new scene information relative to earlier keyframes).

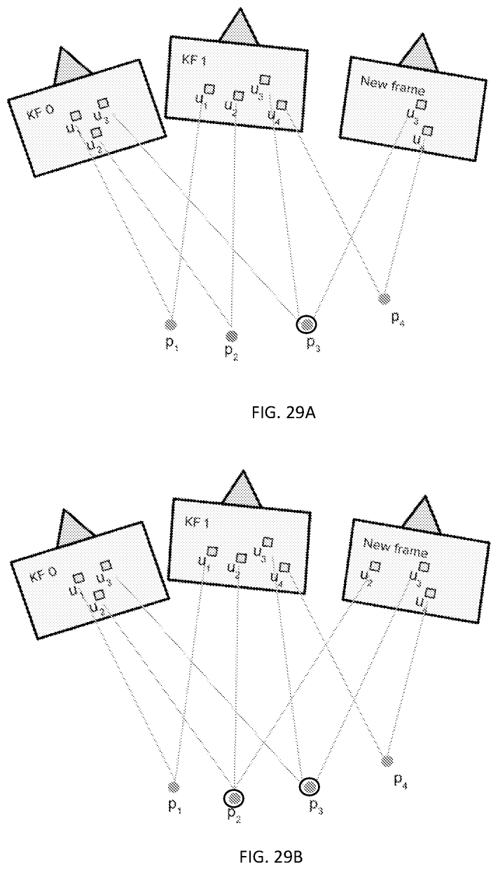

Mobile networks are designed for limited memory and computing resources, so it is equally possible that a feature detection and matching routines on device fails to recognize viable features that a network running on a server would detect and qualify for any necessary N-focal conditions. FIGS. 29A and 29B illustrate this problem. A lightweight feature matching service on a mobile device as in FIG. 29A only recognizes p₃ as a trifocal feature in the new frame and does not detect point p₂ even though this point may otherwise be detectable or matchable. A server-side feature matching service, however and as depicted in FIG. 29B, with its additional computing resources does detect or would be able to detect and match p₂ as a trifocal feature as well as point p₃.

To alleviate these false negatives, in some examples candidate keyframes are based on overlapping features detected across images regardless of N-focal qualification.

In some examples, a guidance feature generates proxy keyframes among new frames by reprojecting the 3D points or 3D N-focal features of at least one prior associate frame, candidate frame or keyframe according to a new frame position. The inter-image parameter evaluation system 1400 detects these reprojected (though not necessarily detected or matched) points within the frustum of the camera at the new frame's pose and compares the quantity of observed reprojected 3D points to a previous frame's quantity of points. In some examples, when the frustum of the new frame observes at least five percent of the 3D points or 3D trifocal features of a previous frame, the new frame is selected as a proxy keyframe. Increased overlap percentages are more likely to ensure that a candidate keyframe generated from an overlapping protocol will similarly be selected as an actual keyframe. Similarly, ever increasing overlap (for example ninety-five percent overlap) is likely to be reject the proxy keyframe as an actual keyframe as the new frame would be substantially similar with respect to scene information and not introduce sufficient new information upon which subsequent frames can successfully build new N-focal features upon or reconstruction algorithms can make efficient use of such superfluous data.

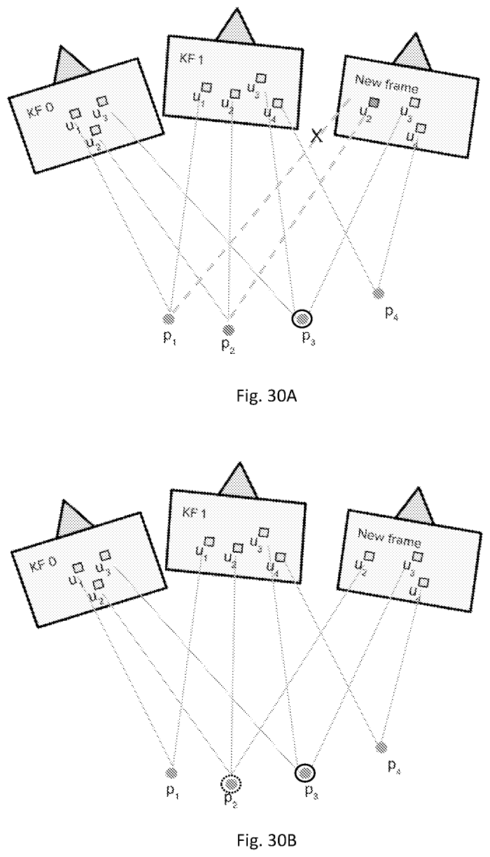

FIG. 30A illustrates reprojecting the points of a previous frame (KF₁ as depicted) relative to the frustum of a new frame. In other words, even though points p₁ and p₂ are not actively detected by the new frame, their 3D data as produced by the previous frames are reprojected nonetheless. In some examples, this reprojection is a virtual detection of features, as they are not actively sensed within the new frame but are presumed detectable if within the new frame's frustum. As depicted in FIG. 30A, the reprojection of p₁ does not pass through the frustum of the new frame, but a reprojection of p₂ does present in the frustum and is therefore deemed as detected by the camera at the new frame. This addition of p₂ as an overlapping point, regardless of actual detection or designation as an N-focal match enables the new frame to be validated against the previous image frame. In some examples, validation means selection as a proxy keyframe and inclusion in a keyframe set or image subset otherwise. In some examples, validation is rejection of an instant frame based on insufficient observation of reprojected points. In some examples, and as depicted in FIG. 30B, designation as an observed overlapping point categorizes p₂ as a proxy trifocal feature for the new frame. In some examples, reprojection is according to a world map data presence of a given feature, such as by augmented reality frameworks. In some examples, the reprojection translates the detected features coordinates according to the previous image frame into a coordinate framework of the additional frame according to SLAM principles, dead reckoning, or visual inertial odometry otherwise.

In some examples, the reprojected 3D points or 3D trifocal points may be displayed to the user, and an instructive prompt provided to confirm the quality or quantity of the overlap with the previous frame. The instructive prompt could be a visual signal such as a displayed check mark or color-coded signal, or numerical display of the percentage of overlapping points with the at least one previous frame. In some examples, the instructive prompt is an audio signal such as a chime, or haptic feedback. Translation or rotation from the new frame's pose can increase the overlap and generate additional prompts of the increased quality of the match, or decrease the overlap and prompt the user that the quality of overlap condition is no longer satisfied or not as well satisfied.

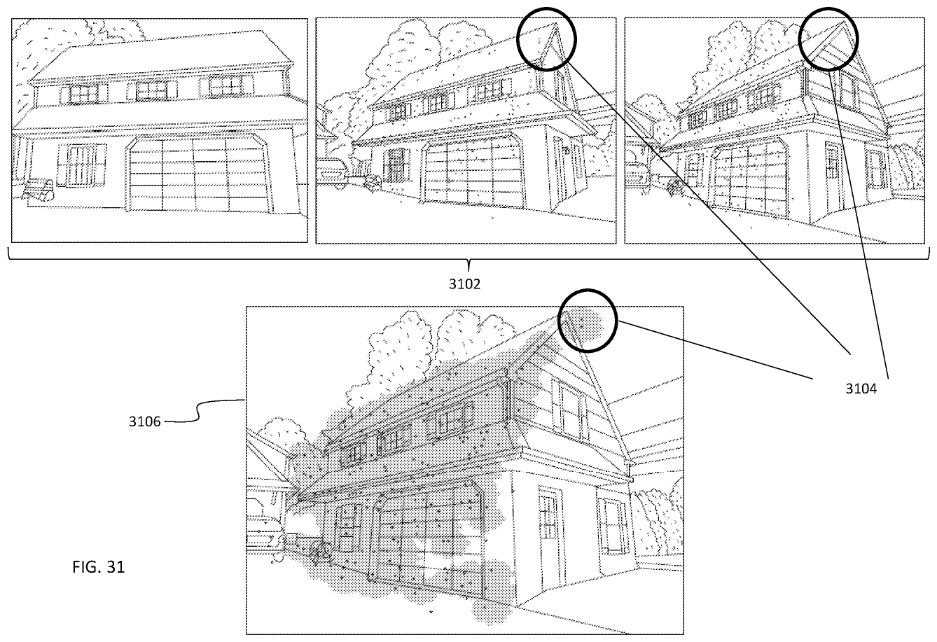

FIG. 31 illustrates experimental data for overlapping reprojection as depicted in FIGS. 30A or 30B. In FIG. 31 a series of images 3102 are captured in succession. Feature matches as between the first and second images are depicted as small dots in the second image, and feature matches as between the second and third image are similarly depicted as small dots in the third image. In some examples, the features matched in the third image are compared to features detected in the first image and matches there (i.e., an N-focal match wherein N=3, a trifocal match) is identified as part of keyframe selection. In some examples, features are reprojected into the third image regardless of detection or matching. For example, in FIG. 31 two features 3104 are present in the second image of images 3102, but they are not detected or matched in the third image. In some examples, these points from the second image are reprojected into the image space of the third image as shown by the presence of feature 3104 in element 3106.

Element 3106 depicts the third image of images 3102 but with reprojected features from the second image and a grayscale mask for regions those reprojected features present. In other words, the grayscale mask provides a visual cue for the degree of overlap element 3106 has with the second image of images 3102. A grayscale portion may be a dilated region around a reprojected feature, such as fixed shaped or gaussian distribution with a radius greater than five, ten, or fifteen pixels about the reprojected point. In some examples, no visual cue is provided and the reprojected points present in the frustum are quantified. Reprojected points greater than five percent of the previous frames detected or matched features indicate the instant frame is suitable for reconstruction due to sufficient overlap with the previous frame.

In some examples, in addition to overlap of reprojected points, an instant frame must also introduce new scene information to ensure the frame is not a substantially similar frame. In some examples, new scene information is measured as the difference between detected features in the instant frame less any matches those detected features have with a previous frame and any reprojected features into that frame. For example, if a second frame among three successive image frames comprises 10 detected features, and the third image comprises 15 detected features, 5 feature matches with the second frame and 3 undetected features from the second image that nonetheless reproject into the third image's frustum, the new information is 7 new detected features (an increase of new information as between the frames by 70%). In some examples, new information gains of 5% or more are sufficient to categorize an instant frame as comprising new information relative to other frames.

With reference to additional intra-image parameters, the angle of the optical axis from a camera or other image capture platform to the object being imaged is relevant. Determining whether an image comprises points that satisfy a 3D reconstruction condition (such as by an intra-image parameter evaluation system), whether a pair of images satisfy a 3D reconstruction condition (such as by an inter-image parameter evaluation system), or whether a coverage metric addresses appropriate 3D reconstruction conditions may be addressed by a camera angle score, or angular perspective metric.

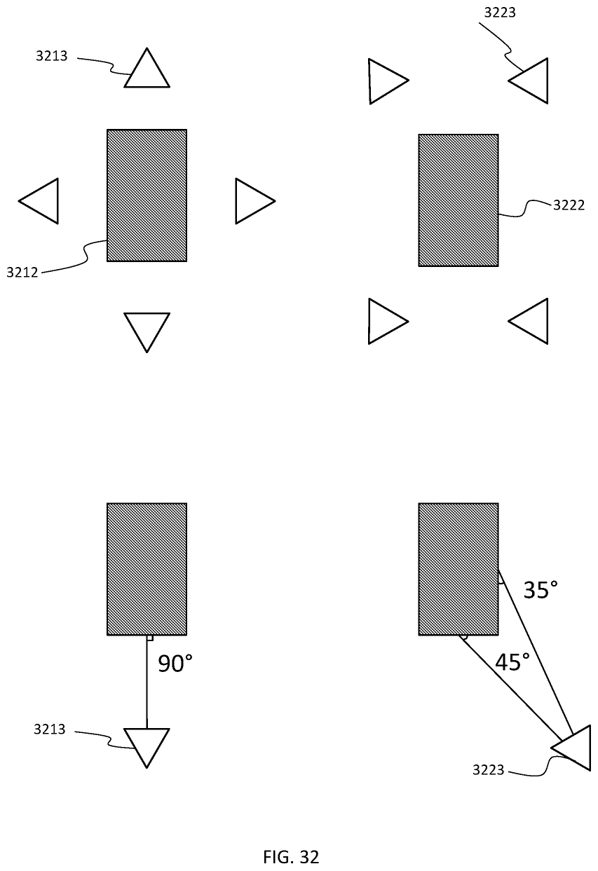

FIG. 32 illustrates a series of top-down orthogonal views of simple structures. Depicted is hypothetical structure 3212 with hypothetical cameras 3213 that are posed to capture frontal parallel images of the surfaces of structure 3212. Also depicted is hypothetical structure 3222 with hypothetical cameras 3223 that are posed to capture obliquely angled images relative to the surfaces of structure 3222. The frontal parallel nature of cameras 3213 relate to the surfaces of 3212 at substantially 90° angular perspectives. This angle is measured as an inside angle relative to a virtual line formed from or generated by connecting a point on the surface(s) captured by camera 3213 and camera 3213 itself (such as the focal point of the camera). Frontal parallel views, such as those in or similar to the relationship between structure 3212 and camera 3213, provide little 3D reconstruction value. Though many features may be present on the captured surface, and these may further be applied to generate correspondences, the 90° angular perspective degrades reconstruction with the particular image. Focal length calculations are unconstrained by this arrangement, and discerning vanishing points to create or implement a three dimensional coordinate system is difficult, if not impossible.

By contrast, the obliquely angled angular perspectives of cameras 3223 about the surfaces of structure 3222 provide inside angles of 45° and 35° for the depicted points on the surfaces. These angular perspectives are indicative of beneficial 3D reconstruction. Images of the surfaces captured by such cameras, and its lines and points, possess rich depth information and positional information, such as vanishing lines, vanishing points and the like.

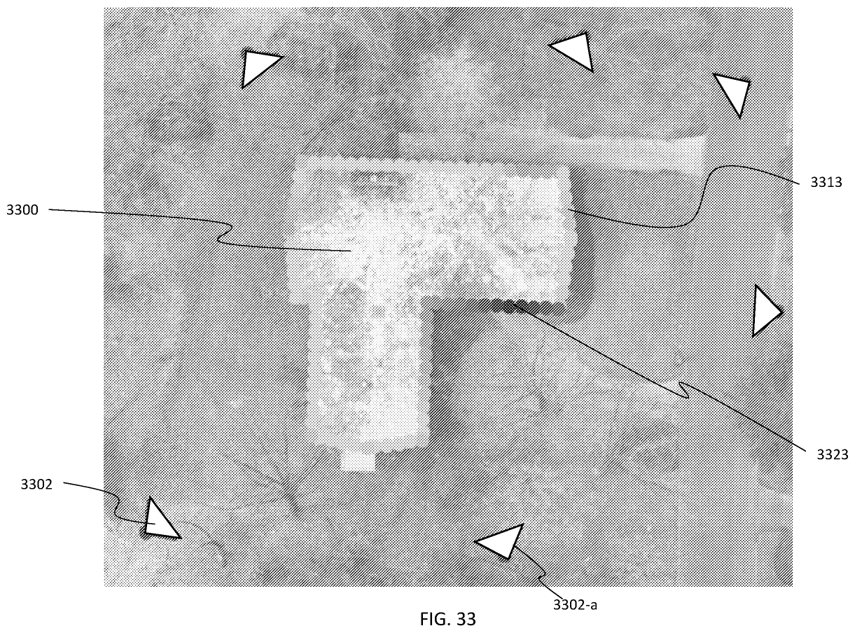

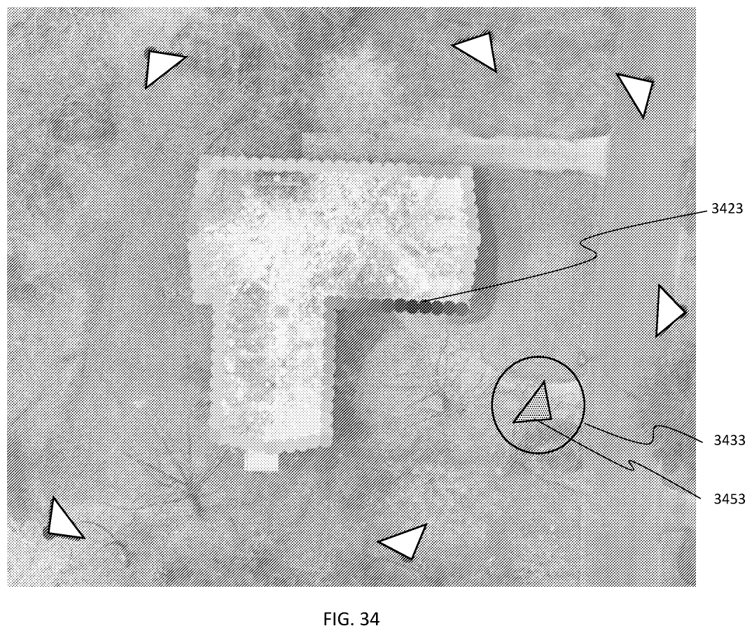

Referring to FIG. 33, a series of cameras 3302 are disposed about structure 3300. Points along its surfaces such as point 3313 and point 3323 are scored for their 3D reconstruction potential based on their angular perspective to a camera. A point observed by at least one camera with an angular perspective at or near 45° is scored for suitability in reconstruction. Sampling of points for angular perspective utility may done by selecting a sampling rate D and generating scores for a surface at P intervals. For example, if a sampling rate S=32, for a 64 ft surface then each sampled point would apply to two feet of the exterior. In some examples, the sampling rate is fixed; in some example the sampling rate is at a fixed geometric interval for the scene (e.g., every 2 meters), in some examples the sampling rate is fixed as an angular function of the camera frustum (e.g., every ten degrees a sample point is formed). In some examples, the angular perspective is measured as an angle of incidence between any point p and camera position (e.g., focal point) c and generated according to the following relationship (Eq. 1):

$${g}_{p , c} = \{ \begin{matrix}arc cos ( \vec{{l}_{p}} ∘ \vec{{c}_{p}} ) & arc cos ( \vec{{l}_{p}} ∘ \vec{{c}_{p}} ) \leq 90 ° \\ 90 ° − arc cos ( \vec{{l}_{p}} ∘ \vec{{c}_{p}} ) & arc cos ( \vec{{l}_{p}} ∘ \vec{{c}_{p}} ) > 90 °\end{matrix}$$

Where Iₚ is the line of the structure from which the sample point is derived, and cₚ is the line between the camera and sample point. Angle of incidence g_{c,p} represents the angle between the lines, with the domain being less than 90° (in the instance of angles larger than 90° the complimentary angle is used, so that the shorter angle generated by the lines is applied for analysis). A dot product is represented by lₚ o cₚ.

A camera angle score or angular perspective metric may be calculated using the following relationship (Eq. 2):

$${a}_{p , c} = \{ \begin{matrix}\frac{{g}_{p , c}}{45 °} & {g}_{p , c} \leq 45 ° \\ \frac{90 ° − {g}_{p , c}}{45 °} & {g}_{p , c} > 45 °\end{matrix}$$

The above relationship presumes a 45° angle is optimal for 3D reconstruction, though this domain may be replaced with other angular values to loosen or tighten sensitivity.

High camera angle scores (i.e., scores approaching a value of 1 according to Eq. 2) may be indicative of suitability of that image or portion of image data for 3D reconstruction. Scores below a predetermined threshold (in some examples, the predetermined threshold is 0.5 according to Eqs. 1 and 2) may indicate little or no 3D reconstruction value for those images or portions of imagery. In some examples, suitability for reconstruction generally does not require that particularly sampled point be used for reconstruction, but instead is indicative that image itself is suitable for three-dimensional reconstruction. For example, the lightly shaded point 3313 indicates cameras have captured data in that region of the surface from an angular perspective beneficial to 3D reconstruction. Dark shaded point 3323 indicates that even if a camera among cameras 3302 has collected imagery for that portion of structure 3300, such images do not have beneficial 3D reconstruction value as there is no camera with an angular perspective at or near 45°. As depicted in FIG. 33, camera 3302-a has a pose that is likely to have captured the surface that point 3323 is associated with, however, the features captured by camera 3302-a that are on that surface near point 3323 are associated with low 3D reconstruction value. In some embodiments, an intra-image parameter check would flag the image capture as unsuitable for 3D reconstruction, or an inter-image parameter evaluator would not match features that fall upon that surface near point 3323 despite co-visibility of those features in other images.

In some examples, an acceptable suitability score (e.g., a score above 0.5 according to Eqs. 1 and 2) designates or selects the image as eligible for a three-dimensional reconstruction pipeline; meaning a suitable score does not require the image or portions of the image to be used in reconstruction. In this way, the angular perspective score may be a check, such as intra-image or inter-image, among other metrics for selecting an image for a particular computer vision pipeline task.

In some embodiments, if features have been gathered near points 3323 or correspondences made with features near points 3323, a camera may still need further pose refinements to capture a suitable image for 3D reconstruction. In some embodiments, points near such poor angular perspective scores are not used for feature correspondence or identification altogether. In some embodiments, an intra-image parameter evaluation system analyzes points within a display and calculates the angular perspective. If there are points without angular perspectives at or near 45° instructive prompts may call to action camera pose changes (translation or rotation or both) to produce more beneficial angular perspective scores for the points on the surfaces of the structure in the image frame.

In some embodiments, an intra-image parameter evaluation system may triangulate new camera poses, such as depicted in FIG. 34 and candidate pose 3453 or candidate region 3433 where imagery from that candidate pose or proximate in that candidate region is more likely to capture angular perspectives of points 3423 with the desired metric. For example, for a given point with an angular perspective score below a predetermined threshold (e.g., below 0.5 according to the operations of Eqs. 1 or 2), a suggested angle of incidence is generated from point. Candidate poses satisfying this angle of incidence may then be identified, such as placement on an orthogonal image according to line of sight, or projected in augmented reality on a device and instructive prompts given to guide the user to such derived camera poses.

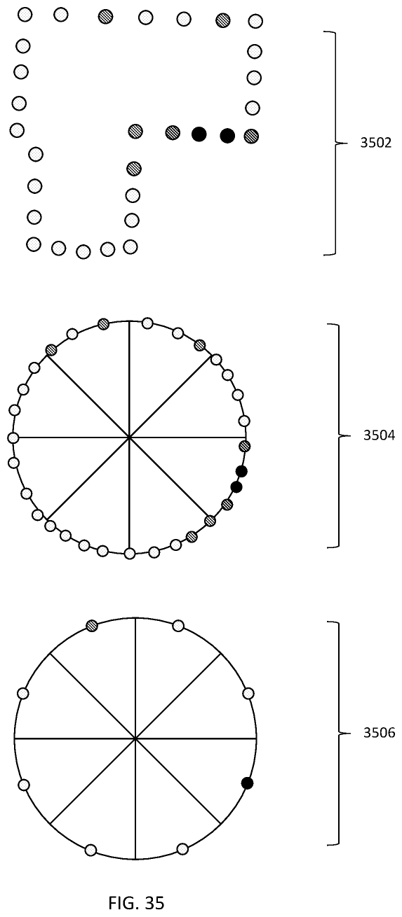

FIG. 35 illustrates a series of analytical frameworks for angular perspective scores according to some embodiments. A sampling of scored points 3502 for structure 3300 is collected, depicting certain portions of the structure with angular perspective indicate of beneficial 3D reconstruction potential, and certain portions with low angular perspective scores. A rough outline of structure 3300 can be discerned from such sampling. In some embodiments, the sampling is projected onto a unit circle 3504, and may even be further processed to divide the unit circle into segments, and an aggregate value of angular perspective scores for such segment applied as in 3506 (for example by applying a median value for the angular perspective scores that fall within such segment). This provides quality metric of the coverage that can inform a degree of difficulty in reconstructing a three-dimensional representation of an object captured by the images forming the basis of the analytical framework. That is, even if numerous correspondences exist between the various images that can derive the camera positions, such as determined by inter-image feature matching 1460, the images may still not be useful for modeling from those camera positions. For example, the low angular perspective scores for portions of 3502 or 3504 or 3506 (the darker dots among the lighter ones) may lead to rejecting the data set on the whole for reconstruction or comparatively ranking the data set for subsequent processing (such as aggregating with other images, using alternative reconstruction algorithms, or routing to alternative quality checks). In some examples, the presence of at least one low angular perspective score designates it as needed additional resources.

The output of 3504 or 3506 may be used to indicate where additional images with additional poses need to be captured, or to score a coverage metric. A unit circle with more than one arc segment that is not suitable for 3D reconstruction may need additional imagery, or require certain modeling protocols and techniques.

In some embodiments, a camera angle score or angular perspective is measured on an orthographic, top down, or aerial image such as depicted in FIGS. 33 and 34. In some embodiments, AR output for surface anchors in an imager's field of view provides an orientation relationship of the surface to the imager, and then any point upon that surface can be analyzed for angular perspective based on a ray from the imager to the point using the AR surface orientation.

The technology as described herein may have also been described, at least in part, in terms of one or more embodiments, none of which is deemed exclusive to the other. Various configurations may omit, substitute, or add various procedures or components as appropriate. For instance, in alternative configurations, the methods may be performed in an order different from that described, or combined with other steps, or omitted altogether. This disclosure is further non-limiting and the examples and embodiments described herein does not limit the scope of the invention.

It is further understood that modifications and changes to the disclosures herein are suggested to persons skilled in the art, and are included within the scope of this description and the appended claims and review of aspects below.

In some aspects, disclosed is a computer-implemented method for generating a data set for computer vision operations, the method comprising detecting features in an initial image frame associated with a camera having a first pose, evaluating features in an additional image frame having a respective additional pose, selecting at least one associate frame based on the evaluation of the additional frame according to a first selection criteria, evaluating a second plurality of image frames, at least one image frame of the second plurality of image frames having a new respective pose, selecting at least one candidate frame from the second plurality of image frames; and compiling a keyframe set comprising the at least one candidate frame.

The method as described in the aspect above, wherein detecting features in an initial image frame comprises evaluating an intra-image parameter.

The method as described among the aspects above, wherein the intra-image parameter is a framing parameter.

The method as described among the aspects above, wherein evaluating the additional image frame comprises evaluating a first plurality of image frames.

The method as described among the aspects above, wherein the first selection criteria for evaluating features in the additional image frame comprises identifying feature matches between the initial image frame and the additional frame.

The method as described among the aspects above, wherein the number of feature matches is above a first threshold.

The method as described among the aspects above, wherein the first threshold is 100.

The method as described among the aspects above, wherein the number of feature matches is below a second threshold.

The method as described among the aspects above, wherein the second threshold is 10,000.

The method as described among the aspects above, wherein the first selection criteria for evaluating features in the additional image frame further comprises exceeding a prescribed camera distance between the initial image frame and the additional frame.

The method as described among the aspects above, wherein the prescribed camera distance is a translation distance.

The method as described among the aspects above, wherein the translation distance is based on an imager-to-object distance.

The method as described among the aspects above, wherein the prescribed camera distance is a rotation distance.

The method as described among the aspects above, wherein the rotation distance is at least 2 degrees.

The method as described among the aspects above, wherein selecting the at least one associate frame further comprises secondary processing.

The method as described among the aspects above, wherein secondary processing comprises at least one of an intra-image parameter check, a feature match quantity, a feature match diversity, or a semantic diversity of a subject within the additional frame.

The method as described among the aspects above, wherein evaluating the second plurality of images comprises evaluating the initial image frame, the associate frame and one other received image frame.

The method as described among the aspects above, wherein selecting the least one candidate frame further comprises satisfying a matching criteria.

The method as described among the aspects above, wherein satisfying a matching criteria comprises identifying trifocal features with the initial image frame, associate frame and one other received image frame of the second plurality of image frames.

The method as described among the aspects above, wherein at least three trifocal features are identified.

The method as described among the aspects above, wherein selecting the at least one candidate frame further comprises secondary processing.

The method as described among the aspects above, wherein secondary processing comprises at least one of an intra-image parameter check, a feature match quantity, a feature match diversity, or a semantic diversity of a subject within the additional frame.

The method as described among the aspects above, further comprising generating a multi-dimensional model of a subject within the keyframe set.

The method as described among the aspects above wherein selecting is based on a first-to-satisfy protocol.

The method as described among the aspects above wherein selecting is based on a deferred selection protocol.

The method as described among the aspects above, wherein the initial image frame is a first captured frame of a given capture session.

The method as described among the aspects above, wherein the initial image frame is a sequence-independent frame.

The method as described among the aspects above, wherein the selected associate frame is an image frame proximate to the image frame that satisfies the first selection criteria.

The method as described among the aspects above, wherein the selected candidate frame is an image frame proximate to the image frame that satisfies the matching criteria.

An intra-image parameter evaluation system configured to perform any of the aspects, elements or tasks as described in the aspects above.

One or more non-transitory computer readable medium comprising instructions to execute any of the aspects, elements or tasks as described in the aspects above.

A computer-implemented method for generating a data set for computer vision operations, the method comprising: receiving a first plurality of reference image frames having respective camera poses; evaluating a second plurality of image frames, wherein at least one image frame of the second plurality of image frames is unique relative to the reference image frames; selecting at least one candidate frame from the second plurality of image frames based on feature matching with at least two image frames from the first plurality of reference frames; and compiling a keyframe set comprising the at least one candidate frame.

The method as described among the aspects above, wherein feature matching further comprises satisfying a matching criteria.

The method as described among the aspects above, wherein satisfying a matching criteria comprises identifying trifocal features.

The method as described among the aspects above, wherein at least three trifocal features are identified.

The method as described among the aspects above, wherein selecting the at least one candidate frame further comprises secondary processing.

The method as described among the aspects above, wherein secondary processing comprises at least one of an intra-image parameter check, a feature match quantity, a feature match diversity, or a semantic diversity of a subject within the additional frame.

The method as described among the aspects above, further comprising generating a multi-dimensional model of a subject within the keyframe set.

The method as described among the aspects above, wherein the selected candidate frame is an image frame proximate to the image frame that satisfies the matching criteria.

An intra-image parameter evaluation system configured to perform any of the aspects, elements and tasks as described above.

One or more non-transitory computer readable medium comprising instructions to execute any of the aspects, elements and tasks described above.

A computer-implemented method for generating a frame reel of related input images, the method comprising: receiving an initial image frame at a first camera position; evaluating at least one additional image frame related to the initial image frame; selecting the at least one additional image frame based on a first selection criteria; evaluating at least one candidate frame related to the selected additional image frame; selecting the at least one candidate frame based on a second selection criteria; generating a cumulative frame reel comprising at least the initial image frame, selected additional frame, and selected candidate frame.

The method as described among the aspects above, wherein the initial image frame is a first captured frame of a given capture session.

The method as described among the aspects above, wherein the initial image frame is a sequence-independent frame.

The method as described among the aspects above, wherein the at least one additional image frame is related to the initial frame by geographic proximity.

The method as described among the aspects above, wherein the at least one additional image frame is related to the initial frame by a capture session identifier.

The method as described among the aspects above, wherein the at least one additional image frame is related to the initial frame by a common data packet identifier.

The method as described among the aspects above, wherein the first selection criteria is one of feature matching or prescribed distance.

The method as described among the aspects above, wherein the feature matching comprises at least 100 feature matches between the initial image frame and at least one additional image frame.

The method as described among the aspects above, wherein the feature matching comprises exceeding a prescribed distance.

The method as described among the aspects above, wherein the prescribed distance is a translation distance.

The method as described among the aspects above, wherein the translation distance is based on an imager-to-object distance.

The method as described among the aspects above, wherein the prescribed distance is a rotation distance.

The method as described among the aspects above, wherein the rotation distance is 2 degrees.

The method as described among the aspects above, wherein the first selection criteria further comprises secondary processing.

The method as described among the aspects above, wherein secondary processing comprises at least one of an intra-image parameter check, a feature match quantity, a feature match diversity, or a semantic diversity of a subject within the additional frame.

The method as described among the aspects above, wherein the second selection criteria is one of feature matching or N-focal feature matching.

The method as described among the aspects above, wherein the feature matching comprises at least 100 feature matches between the at least one additional image frame and the at least one candidate frame.

The method as described among the aspects above, wherein the N-focal feature matching comprises identifying trifocal features among the initial frame, the at least one additional image frame and the at least one candidate frame.

The method as described among the aspects above, wherein the number of trifocal features is at least 3.

The method as described among the aspects above, wherein the second selection criteria further comprises secondary processing.

The method as described among the aspects above, wherein secondary processing comprises at least one of an intra-image parameter check, a feature match quantity, a feature match diversity, or a semantic diversity of a subject within the candidate frame.

The method as described among the aspects above, wherein the selected additional frame is an image frame proximate to the image frame that satisfies the first selection criteria.

The method as described among the aspects above, wherein the selected candidate frame is an image frame proximate to the image frame that satisfies the second selection criteria.

An intra-image parameter evaluation system configured to perform any of the aspects, elements or tasks as described above.

One or more non-transitory computer readable medium comprising instructions to execute any one of the aspects, elements or tasks as described above.

A computer-implemented method for guiding image capture by an image capture device, the method comprising: detecting features in an initial image frame associated with a camera having a first pose; reprojecting the detected features to a new image frame having a respective additional pose; evaluating a degree of overlapping features determined by a virtual presence of the reprojected detected features in a frustum of the image capture device at a second pose of the new frame; and validating the new frame based on the degree of overlapping features.

The method as described among the aspects above, wherein reprojecting the detected features comprises placing the detected features in a world map according to an augmented reality framework operable by the image capture device.

The method as described among the aspects above, wherein reprojecting the detected features comprises estimating a position of the detected features in a coordinate space of the new frame.

The method as described among the aspects above, wherein the estimated position is according to simultaneous localization and mapping, dead reckoning, or visual inertial odometry.

The method as described among the aspects above, wherein evaluating the presence of the reprojected detected features comprises calculating a percentage of reprojected features in the new frame frustum.

The method as described among the aspects above, wherein the percentage is at least 5%.

The method as described among the aspects above, wherein validating the new frame further comprises rejecting the frame for capture by the image capture device.

The method as described among the aspects above, wherein validating the new frame further comprises displaying an instructive prompt to adjust a parameter of the image capture device.

The method as described among the aspects above, wherein validating the new frame further comprises displaying an instructive prompt to adjust a parameter of the new frame. The method as described among the aspects above, wherein the parameter of the new frame is the degree of overlapping reprojected features.

The method as described among the aspects above, wherein the instructive prompt is to adjust a translation or rotation of the image capture device.

The method as described among the aspects above, wherein validating the new frame further comprises designating an overlapping reprojected point as an N-focal feature.

The method as described among the aspects above, wherein validating the new frame further comprises displaying an instructive prompt to accept the new frame.

The method as described among the aspects above, wherein accepting the new frame comprises submitting the new frame to a keyframe set.

The method as described among the aspects above, wherein validating the new frame further comprising detecting new information within the new frame.

The method as described among the aspects above, wherein new information comprises features unique to the new frame.

The method as described among the aspects above, wherein the unique features are at least 5% of the sum of reprojected detected features and unique features.

The method as described among the aspects above, wherein accepting the new frame further comprises selecting an image frame proximate to the image frame that satisfies the validation.

An intra-image parameter evaluation system configured to perform any of the aspects, elements or tasks as described above.

One or more non-transitory computer readable medium comprising instructions to execute any one aspects, elements or tasks as described above.

A computer-implemented method for analyzing an image, the method comprising: receiving a two-dimensional image, the two dimensional image comprising at least one surface of a building object, wherein the two-dimensional image has an associated camera; generating a virtual line between the camera and the at least one surface of the building object; and deriving an angular perspective score based on an angle between the at least one surface of the building object and the virtual line.

The method as described among the aspects above, wherein the angle is an inside angle.

The method as described among the aspects above, wherein the angle informs a degree of depth information that can be extracted from the image.

The method as described among the aspects above, further comprising generating an instructive prompt within a viewfinder of the camera based on the angular perspective score.

The method as described among the aspects above, further comprising, responsive to the angular perspective score being greater than a predetermined threshold score, extracting depth information from the two-dimensional image.

The method as described among the aspects above, wherein the angle informs the three-dimensional reconstruction suitability of the image.

The method as described among the aspects above, wherein the virtual line is between a focal point of the camera and the at least one surface of the building object.

The method as described among the aspects above, wherein the virtual line is between the camera and a selected point on the at least one surface.

The method as described among the aspects above, wherein a selected point is a sampled point according to a sampling rate.

The method as described among the aspects above, wherein the sampling rate is fixed for each surface.

The method as described among the aspects above, wherein the sampling rate is a geometric interval.

The method as described among the aspects above, wherein the sampling rate is an angular interval.

The method as described among the aspects above, wherein the angular perspective score is based on a dot product of the angle.

The method as described among the aspects above, where in the angular perspective score is above 0.5.

The method as described among the aspects above, further comprising selecting the image for a three-dimensional reconstruction pipeline.

An intra-image parameter evaluation system configured to perform any of the aspects, elements or tasks as described in above.

One or more non-transitory computer readable medium comprising instructions to execute any one aspects, elements or tasks as described above.

A computer-implemented method for analyzing images, the method comprising: receiving a plurality of two-dimensional images, each two-dimensional image comprising at least one surface of a building object, wherein each two-dimensional image has an associated camera pose; for each two-dimensional image of the plurality of two-dimensional images, generating a virtual line from a camera associated with the two-dimensional image and the at least one surface; deriving an angular perspective score for each of the plurality of two-dimensional images based on an angle between the at least one surface of the building object and the virtual line; and evaluating the plurality of two-dimensional images to determine a difficulty with respect to reconstructing a three-dimensional model of the building object using the plurality of two-dimensional images based on the angles.

The method as described among the aspects above, further comprising, for each two-dimensional image of the plurality of two-dimensional images, associating a plurality of points of the at least one surface of the building object.

The method as described among the aspects above, wherein associating the plurality of points of the at least one surface of the building object is based on an orthogonal image depicting an orthogonal view of the building object.

The method as described among the aspects above, further comprising receiving the orthogonal image.

The method as described among the aspects above, further comprising generating the orthogonal image based on the plurality of two-dimensional images.

The method as described among the aspects above, sampling the number of associated points.

The method as described among the aspects above, further comprising projecting the plurality of sampled associated points to a unit circle segmented into a plurality of segments, wherein each segment of the plurality of segments comprises an aggregated value for angular perspective score.

The method as described among the aspects above, wherein the aggregated value is based on a median value

The method as described among the aspects above, wherein evaluating the plurality of two-dimensional images is further based on the median values associated with the plurality of segments of the unit circle.

The method as described among the aspects above, further comprising generating an instructive prompt based on the evaluation to generate additional cameras for the plurality of two-dimensional images.

The method as described among the aspects above, further comprising deriving a new pose for the additional camera based on a suggested angle of incidence from one or more points associated with an orthogonal image, wherein the feedback notification includes the new pose.

The method as described among the aspects above, further comprising assigning the plurality of two-dimensional images for subsequent processing.

The method as described among the aspects above, wherein subsequent processing comprises deriving new camera poses for additional two-dimensional images for the plurality of two-dimensional images.

The method as described among the aspects above, wherein subsequent processing comprises aggregating with additional two-dimensional images related to the building object.

The method as described among the aspects above, further comprising reconstructing the three-dimensional model based on the plurality of two-dimensional images.

The method as described among the aspects above, wherein the angle between the at least one surface of the building object and the virtual line is an inside angle.

The method as described among the aspects above, further comprising: for each point of the plurality of points, calculating a three-dimensional reconstruction score based on the angle; wherein evaluating the plurality of two-dimensional images is further based on the angular perspective scores.

The method as described among the aspects above, wherein evaluating the plurality of two-dimensional images comprises comparing the angular perspective score to a predetermined threshold score.

The method as described among the aspects above, further comprising responsive to at least one of the angular perspective scores being less than a predetermined threshold score, generating an instructive prompt.

The method as described among the aspects above, wherein the instructive prompt comprises camera pose change instructions.

The method as described among the aspects above, wherein the camera pose change instructions comprise at least one of changes in translation of the camera and rotation of the camera.

The method as described among the aspects above, further comprising responsive to at least one of the angular perspective scores being less than a predetermined threshold score, triangulating a new camera location based on the at least one angular perspective score.

The method as described among the aspects above, wherein the new camera location comprises a pose.

The method as described among the aspects above, wherein the new camera location comprises a region.

The method as described among the aspects above, wherein triangulating a new camera location further comprises generating a suggested angle of incidence.

An intra-image parameter evaluation system configured to perform any of the aspects, elements or tasks as described above.

One or more non-transitory computer readable medium comprising instructions to execute any one of aspects, elements or tasks described above.

1.-131. (canceled)

132. A computer-implemented method for generating a data set for computer vision operations, the method comprising:
detecting features in a first image frame associated with a camera having a first pose;
evaluating features of an additional image frame of a first plurality of image frames that excludes the first image frame, each additional image frame associated with a camera having a respective additional pose;
selecting at least one second frame from the first plurality of image frames based on the evaluated features of the additional frame satisfying a first selection criteria of a threshold number of feature matches with the first image frame;
evaluating features of an additional image frame of a second plurality of image frames excluding the first image frame and first plurality of image frames, the at least one additional image frame of the second plurality of image frames having a new respective pose;
selecting at least one keyframe from the second plurality of image frames based on the at least one keyframe satisfying a second selection criteria of a threshold number of trifocal features matches with the first frame and the selected at least one second frame; and
compiling a keyframe set comprising the first image frame, the at least one second image frame, and the at least one keyframe.

133. A computer-implemented method for generating a data set for computer vision operations, the method comprising:
detecting features in an initial image frame associated with a camera having a first pose;
evaluating features of an additional image frame having a respective additional pose;
selecting at least one associate frame a first plurality of image frames based on the evaluation of the additional frame according to a first selection criteria;
evaluating a second plurality of image frames, at least one image frame of the second plurality of image frames having a new respective pose;
selecting at least one candidate frame from the second plurality of image frames; and
compiling a keyframe set comprising the at least one candidate frame.

134. The method of claim 133, wherein the first selection criteria for evaluating features of the additional image frame comprises identifying feature matches between the initial image frame and the additional frame.

135. The method of claim 134, wherein the number of feature matches is above a first threshold.

136. The method of claim 135, wherein the first threshold is 100.

137. The method of claim 134, wherein the number of feature matches is below a second threshold.

138. The method of claim 137, wherein the second threshold is 10,000.

139. The method of claim 133, wherein the first selection criteria for evaluating features in the additional image frame further comprises exceeding a prescribed camera distance between the initial image frame and the additional frame.

140. The method of claim 139, wherein the prescribed camera distance is a translation distance.

141. The method of claim 140, wherein the translation distance is based on an imager-to-object distance.

142. The method of claim 133, wherein selecting the least one candidate frame further comprises satisfying a matching criteria.

143. The method of claim 142, wherein satisfying a matching criteria comprises identifying trifocal features with the initial image frame, associate frame and one other received image frame of the second plurality of image frames.

144. The method of claim 143, wherein at least three trifocal features are identified.

145. The method of claim 133, further comprising generating a multi-dimensional model of a subject within the keyframe set.

146. A system comprising:
one or more processors configured to:
detect features in a first image frame associated with a camera having a first pose;
evaluate features of an additional image frame of a first plurality of image frames that excludes the first image frame, each additional image frame associated with a camera having a respective additional pose;
select at least one second frame from the first plurality of image frames based on the evaluated features of the additional frame satisfying a first selection criteria of a threshold number of feature matches with the first image frame;
evaluate features of an additional image frame of a second plurality of image frames excluding the first image frame and first plurality of image frames, the at least one additional image frame of the second plurality of image frames having a new respective pose;
select at least one keyframe from the second plurality of image frames based on the at least one keyframe satisfying a second selection criteria of a threshold number of trifocal features matches with the first frame and the selected at least one second frame; and
compile a keyframe set comprising the first image frame, the at least one second image frame, and the at least one keyframe.

147. A computer-implemented method for generating a data set for computer vision operations, the method comprising:
receiving a first plurality of reference image frames having respective camera poses;
evaluating a second plurality of image frames, wherein at least one image frame of the second plurality of image frames is unique relative to the reference image frames;
selecting at least one candidate frame from the second plurality of image frames based on feature matching with at least two image frames from the first plurality of reference frames; and
compiling a keyframe set comprising the at least one candidate frame.

148. A computer-implemented method for generating a frame reel of related input images, the method comprising:
receiving an initial image frame at a first camera position;
evaluating at least one additional image frame related to the initial image frame;
selecting the at least one additional image frame based on a first selection criteria;
evaluating at least one candidate frame related to the selected additional image frame;
selecting the at least one candidate frame based on a second selection criteria;
generating a cumulative frame reel comprising at least the initial image frame, selected additional frame, and selected candidate frame.

149. A computer-implemented method for guiding image capture by an image capture device, the method comprising:
detecting features in an initial image frame associated with a camera having a first pose;
reprojecting the detected features to a new image frame having a respective additional pose;
evaluating a degree of overlapping features determined by a virtual presence of the reprojected detected features in a frustum of the image capture device at a second pose of the new frame; and
validating the new frame based on the degree of overlapping features.

150. A computer-implemented method for analyzing an image, the method comprising:
receiving a two-dimensional image, the two dimensional image comprising at least one surface of a building object, wherein the two-dimensional image has an associated camera;
generating a virtual line between the camera and the at least one surface of the building object; and
deriving an angular perspective score based on an angle between the at least one surface of the building object and the virtual line.

151. A computer-implemented method for analyzing images, the method comprising:
receiving a plurality of two-dimensional images, each two-dimensional image comprising at least one surface of a building object, wherein each two-dimensional image has an associated camera pose;
for each two-dimensional image of the plurality of two-dimensional images, generating a virtual line from a camera associated with the two-dimensional image and the at least one surface;
deriving an angular perspective score for each of the plurality of two-dimensional images based on an angle between the at least one surface of the building object and the virtual line; and
evaluating the plurality of two-dimensional images to determine a difficulty with respect to reconstructing a three-dimensional model of the building object using the plurality of two-dimensional images based on the angles.
